(19) United States
(12) Patent Application Publication
(10) Pub. No.: US 2019/0010268 A1
(43) Pub. Date: Jan. 10, 2019

(54) PHOTOACTIVATABLE FOULING-RESISTANT COPOLYMERS

(71) Applicant: ARROW INTERNATIONAL, INC., Reading, PA (US)

(72) Inventors: ZHENG ZHANG, CAMBRIDGE, MA (US); FANNI TOROK, CAMBRIDGE, MA (US); JUN LI, CAMBRIDGE, MA (US); MICHAEL BOUCHARD, READING, PA (US); JOHN VICTOR, KUNKLETOW, PA (US)

(73) Assignee: ARROW INTERNATIONAL, INC., Reading, PA (US)

(21) Appl. No.: 15/752,456

(22) PCT Filed: Aug. 12, 2016
(86) PCT No.: PCT/US2016/046750

§ 371 Date: Feb. 13, 2018

Related U.S. Application Data
(60) Provisional application No. 62/205,397, filed on Aug. 14, 2015.

(51) Int. Cl. C08F 220/30; C08F 220/38; C08F 220/56; C08F 2/48; C08F 232/06; C08J 7/18

(52) U.S. Cl. CPC C08F 220/30; C08F 220/38; C08F 220/56; C08F 2/48; C08F 232/06; C08J 7/18; C08J 2333/14; C08F 2220/387; C08F 2220/301; C08F 2220/303; C08F 2500/01; C08F 2800/20; C08F 2220/382

(57) ABSTRACT

A photoactivatable fouling-resistant copolymer composed of a photoactivatable monomer and a hydrophilic monomer is disclosed. The photoactivatable monomer includes an aryl ketone derivative having one or more polar groups or alkyl groups.

### TECHNICAL FIELD

The disclosure generally relates to novel copolymers that are photoactivatable and fouling-resistant, and more particularly to novel copolymers that are capable of forming covalent bonds to surfaces to form a fouling-resistant coating for medical devices.

### BACKGROUND

Hydrophilic polymers, in particular those containing zwitterionic or betaine moieties, are often used for surface modification of medical devices, as they have been shown to reduce the adhesion of microorganisms, significantly cutting down the risk of infection as well as thrombosis. To date, betaine polymer brushes have been grafted-from substrates through surface-initiated polymerization to achieve the best anti-fouling performance and in vivo stability.

Additionally, it is also known to exploit the photoactivity of certain polymers such as benzophenone in order to covalently attach these polymers to the surface of various substrates, including organic and inorganic substrates. Photoactivatable polymers may be activated by light energy to form hydrophilic coatings on substrates that are equivalent to polymer brushes. Because benzophenone-containing monomers can be conveniently combined with a number of different, functional comonomers, surface-attached polymer gels have been shown to be a versatile method for tailoring surface properties of solid substrates, such as glass-slides and plastic substrates. Although this reaction is not selective, it is known that benzophenone-containing polymers can be attached and cross-linked in a simple, one-step photo-reaction to organic surfaces.

Successful applications of such coatings have been reported for surfaces ranging from some biomedical and bioanalytical devices to more sophisticated microsystems, such as surface-attached artificial cilia. The latter has also included the direct attachment of benzophenone-polymers to pure organic surfaces, such as biological tissue and plastic chips. Furthermore, U.S. Pat. No. 8,349,410 issued on Jan. 8, 2013 to Huang et al. discloses a method of altering the biocidal activity of a surface by applying a polymer in solution to the surface, wherein the polymer comprises covalently attached groups that can be modified to form a radical and covalently attach biocidally active groups to the surface. Norrish type I or Norrish type 11 reactions using a block copolymer with both a biocidal group and a benzophenone group using light energy are disclosed. Although this surface modification method is useful to some extent, the photo-activity and the stability of these and other known photoactivatable polymers is insufficient for certain applications. Furthermore, the solubility of these known photoactivatable polymers is often limited such that forming a coating solution that can be easily applied to a substrate surface is problematic. Additionally, these known photoactivatable polymers do not provide the fouling-resistant properties to surfaces that are required for certain medical device applications. Therefore, there is an unmet need for surface modification polymers that are photoactivatable, fouling-resistant and that can easily form covalently bonded coatings to surfaces.

Accordingly, the present disclosure provides novel photoactivatable copolymers that possess superior fouling-resistant properties and are directed at overcoming the disadvantages set forth above.

### SUMMARY

In accordance with one aspect of the disclosure, a photoactivatable copolymer comprising a photoactivatable monomer including an aryl ketone derivative having one or more polar groups or alkyl groups, and a hydrophilic monomer is disclosed. The photoactivatable copolymer may comprise repeating structural units of formula I:

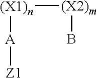

wherein A represents an aryl ketone derivative, Z1 represents one or more polar groups or alkyl groups, X1 represents a hydrocarbyl, X2 represents a hydrocarbyl, B represents a hydrophilic moiety, m is an integer of 1 or greater and n is a integer of 0 or greater.

In accordance with another aspect of the disclosure, a photoactivatable fouling-resistant copolymer is disclosed. The copolymer includes a photoactivatable monomer and a hydrophilic monomer. The photoactivatable monomer includes an aryl ketone derivative having one or more polar groups or alkyl groups.

In accordance with another aspect of the disclosure, a method of modifying a surface of a substrate is disclosed. The method includes applying a photoactivatable fouling-resistant copolymer in solution to the surface of the substrate. The copolymer comprises a photoactivatable monomer including an aryl ketone derivative having one or more polar groups or alkyl groups and a hydrophilic monomer. The method further includes applying energy to the copolymer in solution to form radical groups that covalently bond to functional groups on the surface of the substrate.

### DESCRIPTION OF THE FIGURES

FIG. 1 is a NMR spectrum chart of a photoactivatable copolymer according to one aspect of the present disclosure.

### ABBREVIATIONS AND DEFINITIONS

The following definitions and methods are provided to better define the present disclosure and to guide those of ordinary skill in the art in the practice of the subject matter of the present disclosure. Unless otherwise noted, terms are to be understood according to conventional usage by those of ordinary skill in the relevant art.

When introducing elements of the present invention or the preferred embodiment(s) thereof, the articles “a,” “an,” “the” and “said” are intended to mean that there are one or more of the elements. The terms “comprising,” “including” and “having” are intended to be inclusive and mean that there may be additional elements other than the listed elements.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance can or cannot occur, and that the description includes instances where said event or circumstance occurs and instances where it does not.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations. A-E, A-F. B-D, B-E, B-F, C-D, C-E. and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

References in the specification and concluding claims to parts by weight, of a particular element or component in a composition or article, denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent of a component, unless specifically stated to the contrary, is based on the total weight of the formulation or composition in which the component is included. For example if a particular element or component in a composition or article is said to have 8% weight, it is understood that this percentage is relation to a total compositional percentage of 100%.

“Zwitterion” or “zwitterionic material” refers to a macromolecule, material, or moiety possessing both cationic and anionic groups. In most cases, these charged groups are balanced, resulting in a material with zero net charge. Zwitterionic polymers may include both polyampholytes (e.g, polymers with the charged groups on different monomer units) and polybetaine (polymers with the anionic and cationic groups on the same monomer unit).

“Polymer”, as used herein, includes but is not limited to homopolymers, copolymers, for example block, graft, random, and alternating copolymers, terpolymers, oligomers, etc. and blends and modifications thereof.

“Copolymer”, as used herein, refers to any polymer comprising the reaction product of two or more different monomers. In one embodiment, the copolymer is the reaction product of two or more monomeric species, including a photoactivatable monomer and a hydrophilic monomer wherein the hydrophilic monomer reacts with the photoactivatable monomer during polymerization to form polymerized monomeric units or polymer chains. The copolymer may be a random copolymer or block copolymer, such as an AB or ABA block copolymer or a graft copolymer.

“Monomer,” as used herein, refers to any chemical compound. In some embodiments, a monomer is a chemical compound before it has been polymerized.

“Antimicrobial” as used herein, refers to molecules and/or compositions that kill (i.e., bactericidal), inhibit the growth of (i.e., bacteristatic), and/or prevent fouling by, microorganisms including bacteria, yeast, fungi, mycoplasma, viruses or virus infected cells, cancerous cells, and/or protozoa.

Antimicrobial activity with respect to bacteria may be quantified using a colonization assay pre-incubation with 50% fetal bovine serum for 18-20 hours at 120 RPM at 37° C., which is preferred. Following pre-incubation, samples are placed in Staphylococcus aureus (S. aureus, ATCC 25923) which has been diluted from an overnight culture to a planktonic concentration of 1-3×105 CFU/mL in 1% tryptone soy broth (TSB). Samples are incubated with bacteria for 24-26 hrs with agitation (120 rpm) at 37° C. The concentration of TSB varies with the organism being used. After incubation, the samples are placed in 3 ml PBS for 5 min at 240 RPM at 37° C. to remove bacteria not tightly attached. Then accumulated bacteria on materials are removed by sonication in a new solution of PBS and the total number of bacterial cells quantified through dilution plating. Preferably at least a 1, 2, 3 or 4 log reduction in bacterial count occurs relative to colonization on a control. Similar adherence assays are known in the art for assessing platelet, cell, or other material adhesion to the surface. A surface that has a lower bacterial count on it than on reference polymers may be said to reduce microbial colonization.

“Anti-thrombogenic”, as used herein, refers to the ability of a composition to resist thrombus formation. Anti-thrombogenic activity can be evaluated using ex-vivo flow loop model of thrombosis. Briefly, up to 10 liters of fresh blood are collected from a single animal. This blood is heparinised to prevent coagulation, filtered to remove particulates, and autologous radio-labeled platelets are added. Within eight hours after blood harvesting, coated and uncoated substrates are placed in a flow loop circuit, which pumps blood from a bath over the substrate and then back into the bath. A second internal flow loop circuit can be established for substrate containing a lumen by connecting the two ports of the substrate through a 2nd peristaltic pump. Blood is pumped in the outer circuit at a rate of approximately 2.5 L/min, while blood in the inner circuit is pumped at a rate of approximately 200-400 ml/min. After two hours, the substrates are removed, inspected visually for thrombus formation, and adhered platelets quantified using a Gamma counter. For samples not containing a lumen, only an outer circuit may be used to measure thrombus on the outside of the device.

“Adhesion”, as used herein, refers to the non-covalent or covalent attachment of proteins, cells, or other substances to a surface. The amount of adhered substance may be quantified for proteins using the assay for non-fouling activity or for bacteria with the assay for antimicrobial activity or other relevant assays.

“Bioactive agent” or “active agent” or “biomolecule”, used here synonymously, refers to any organic or inorganic therapeutic, prophylactic or diagnostic agent that actively or passively influences a biological system. For example, a bioactive agent can be an amino acid, antimicrobial peptide, immunoglobulin, an activating, signaling or signal amplifying molecule, including, but not limited to, a protein kinase, a cytokine, a chemokine, an interferon, tumor necrosis factor, growth factor, growth factor inhibitor, hormone, enzyme, receptor-targeting ligand, gene silencing agent, ambisense, antisense, an RNA, a living cell, cohesion, laminin, fibronectin, fibrinogen, osteocalcin, osteopontin, or osteoprotegerin. Bioactive agents can be proteins, glycoproteins, peptides, oligliopeptides, polypeptides, inorganic compounds, organometallic compounds, organic compounds or any synthetic or natural, chemical or biological compound.

“Non-fouling”, as used herein, means that the composition reduces or prevents the amount of adhesion of proteins, including blood proteins, plasma, cells, tissue and/or microbes to the substrate relative to the amount of adhesion to a reference polymer such as polyurethane. Preferably, a device surface will be substantially non-fouling in the presence of human blood. Preferably the amount of adhesion will be decreased at least 20%, 25%, 30%, 35%, 40%, 45%, 50%, 55%, 60%, 65%, 70%, 75%, 80%, 85%, 90%, 95%, 99%, 99.5%, or 99.9% relative to the reference polymer.

Non-fouling activity with respect to protein, also referred to as “protein resistance” may be measured using an ELISA assay. For example, the ability of a composition to prevent the adhesion of blood proteins can be evaluated by measuring fibrinogen absorption through ELISA. Fibrinogen is a blood protein commonly used to assess the ability of a non-fouling surface to resist adsorption, given its important role in mediating platelet and other cell attachment. Briefly, samples are incubated for 90 minutes at 37° C. in 1 mg/mL fibrinogen derived from human plasma, then rinsed three times with 1×PBS and transferred to clean wells. The samples are incubated for another 90 minutes at 37° C. in 10% (v/v) fetal bovine serum to block the areas unoccupied by fibrinogen. The samples are rinsed, transferred to clean wells, and incubated for 1 hour with 5.5 ug/mL horseradish peroxidase conjugated anti-fibrinogen in 10% (v/v) fetal bovine serum. Again the samples are rinsed and transferred to clean wells with 0.1M phosphate-citrate buffer containing 1 mg/mL chromogen of o-phenylenediamine and 0.02% (v/v) hydrogen peroxide. Incubating at 37° C. for 20 minutes produces an enzyme-induced color reaction, which is terminated by the addition of 2.0N sulfuric acid. The absorbance of light intensity can then be measured using a microplate reader to determine the protein adsorption relative to controls. Preferably the amount of adhesion will be decreased at least 20%, 25%, 30%, 35%, 40%, 45%, 50%, 55%, 60%, 65%, 70%, 75%, 80%, 85%, 90%, 95%, 99%, 99.5%, or 99.9% relative to the reference polymer. For mixed protein solutions, such as whole plasma, surface plasmon resonance (SPR) or optical waveguide lightmode spectroscopy (OWLS) can be utilized to measure surface protein adsorption without necessitating the use of individual antigens for each protein present in solution. Additionally, radiolabeled proteins may be quantified on the surface after adsorption from either one protein or complex mixtures.

“Biocompatibility” is the ability of a material to perform with an appropriate host response in a specific situation. This can be evaluated using International Standard ISO 10993. Biocompatible compositions described herein are preferably substantially non-toxic. “Substantially non-toxic”, as used herein, means a surface that is substantially hemocompatible and substantially non-cytotoxic.

“Substantially non-cytotoxic”, as used herein, refers to a composition that changes the metabolism, proliferation, or viability of mammalian cells that contact the surface of the composition. These may be quantified by the International Standard ISO 10993-5 which defines three main tests to assess the cytotoxicity of materials including the extract test, the direct contact test and the indirect contact test.

“Substantially hemocompatible”, as used herein, means that the composition is substantially non-hemolytic, in addition to being non-thrombogenic and non-immunogenic, as tested by appropriately selected assays for thrombosis, coagulation, and complement activation as described in ISO 10993-4.

“A substantially non-hemolytic surface”, as used herein, means that the composition does not lyse 50%, preferably 20%, more preferably 10%, even more preferably 5%, most preferably 1%, of human red blood cells when the following assay is applied: A stock of 10% washed pooled red blood cells (Rockland Immunochemicals Inc, Gilbertsville, Pa.) is diluted to 0.25% with a hemolysis buffer of 150 mM NaCl and 10 mM Tris at pH 7.0. A 0.5 cm2 antimicrobial sample is incubated with 0.75 ml of 0.25% red blood cell suspension for 1 hour at 37° C. The solid sample is removed and cells spun down at 6000 g, the supernatant removed, and the OD414 measured on a spectrophotometer. Total hemolysis is defined by diluting 10% of washed pooled red blood cells to 0.25% in sterile deionized (DI) water and incubating for 1 hour at 37° C., and 0% hemolysis is defined using a suspension of 0.25% red blood cells in hemolysis buffer without a solid sample.

“Complex media”, as used herein, refers to biological fluids or solutions containing proteins or digests of biological materials. Examples include, but are not limited to, cation-adjusted Mueller Hinton broth, tryptic soy broth, brain heart infusion, or any number of complex media, as well as any biological fluid.

“Biological fluids” are fluids produced by organisms containing proteins and/or cells, as well as fluids and excretions from microbes. This includes, but is not limited to, blood, saliva, urine, cerebrospinal fluid, tears, semen, and lymph, or any derivative thereof (e.g., serum, plasma).

“Brush” or “Polymer brush” are used herein synonymously and refer to polymer chains that are bound to a surface generally through a single point of attachment. The polymers can be end-grafted (attached via a terminal group) or attached via a side chain or a position in the polymer chain other than a terminal position. The polymers can be linear or branched. For example, the polymer chains described herein can contain a plurality of side chains that contain non-fouling groups. The side chains can consist of a single non-fouling moiety or monomer and/or a non-fouling oligomer (e.g., 2-10 monomers) or polymer (e.g., >10 monomers).

“Branch” and “Branched tether,” are used interchangeably and refer to a polymer structure which originates from a single polymer chain but terminates in two or more polymer chains. The polymer may be a homopolymer or copolymer. Branched tether polymer structures may be ordered or random, may be composed, in whole or in part, of a non-fouling material, and may be utilized to immobilize one or more bioactive agents. In one embodiment, the branched tether is a dendrimer. A branched tether may be immobilized directly to a substrate or to an undercoating covering a substrate.

“Degradation products” are atoms, radicals, cations, anions, or molecules which are formed as the result of hydrolytic, oxidative, enzymatic, or other chemical processes.

“Density”, as used herein, refers to the mass of material including, but not limited to, non-fouling materials and bioactive agents, that is immobilized per surface area of substrate.

“Inter-polymer chain distance”, as used herein, refers to the distance between non-fouling polymer chains on the surface of the substrate or undercoating. Preferably, this distance is such that the non-fouling chains decrease the penetration of fouling materials into the coating material.

“Effective surface density”, as used herein, means the range of densities suitable to achieve an intended surface effect including, but not limited to, antimicrobial or non-fouling activity, as defined herein.

“Hydrophilic” refers to polymers, materials, or functional groups which have an affinity for water. Such materials typically include one or more hydrophilic functional groups, such as hydroxyl, zwitterionic, carboxy, amino, amide, phosphate, hydrogen bond forming, and/or ether groups.

“Immobilization” or “immobilized”, as used herein, refers to a material or bioactive agent that is covalently or non-covalently attached directly or indirectly to a substrate. “Co-immobilization” refers to immobilization of two or more agents.

“Non-degradable” as used herein, refers to material compositions that do not react significantly within a biological environment either hydrolytically, reductively, enzymatically or oxidatively to cleave into smaller or simpler components.

“Stable”, as used herein, refers to materials which retain greater than 25%, 30%, 35%, 40%, 45%, 50%, 55%, 60%, 65%, 70%, 75%, 80%, 85%, 90%, 95%, or 99% of their original material properties such as surface contact angle, non-fouling, anti-thrombogenic, and/or antimicrobial activity for a time of 1, 7, 14, 30, 90, 365, or 1000 days in PBS containing protein, media, serum, or in vivo.

“Substrate”, as used herein, refers to the material on which the undercoating is applied, or which is formed all or in part of non-fouling material, or on which the non-fouling and/or therapeutic, diagnostic, and/or prophylactic agents are immobilized.

“Coating”, as used herein, refers to any temporary, semi-permanent or permanent layer, or layers, treating or covering a surface. The coating may be a chemical modification of the underlying substrate or may involve the addition of new materials to the surface of the substrate. It includes any increase in thickness to the substrate or change in surface chemical composition of the substrate. A coating can be a gas, vapor, liquid, paste, semi-solid or solid. In addition, a coating can be applied as a liquid and solidified into a solid coating.

“Undercoat” or “Undercoating,” as used herein, refers to any coating, combination of coatings, or functionalized layer covering an entire substrate surface or a portion thereof under an additional coating. In one embodiment, the undercoating is used to alter the properties of one or more subsequent coatings or layers. The undercoating may be formed from a polymer or copolymer. In a preferred embodiment, the undercoat is used to aid in the immobilization of a topcoat on a substrate.

“Undercoating set,” as used herein, refers to a set or group of one or more coatings under the top coating. This group or set of coatings can be applied together or separately covering an entire substrate surface or a portion thereof.

“Topcoat” or “Top coating,” as used herein, refers to any coating, combination of coatings, or functionalized layer applied on top of one or more undercoatings, another top coating, or directly to a substrate surface. A top coating may or may not be the final coating applied to a substrate surface. In one embodiment a top coat is covalently attached to an undercoating. In another embodiment a top coating is encapsulated in a protective coating, which helps extend the top coatings storage life. In a preferred embodiment, the topcoat includes polymeric material.

“Top coating set,” as used herein, refers to a set or group of one or more coatings on top of one or more undercoatings.

“Functionalized substrate”, as used herein, refers to a substrate on which the number of reactive or functional groups has been increased and/or the identity of functional groups has been changed. This may be accomplished by making chemical alterations on the surface with techniques including, but not limited to, aminolysis. In other embodiments, this may be accomplished by the addition of an undercoating or undercoating set which contains functional groups.

“Non-leaching” or “Substantially non-leaching”, as used herein synonymously, means that the compositions retain greater than 50%, 55%, 60%, 65%, 70%, 75%, 80%, 85%, 90%, 95%, 99% of the immobilized coating and/or bioactive agent over the course of 7, 14, 30, 90, 365, or 1000 days in phosphate buffered saline (PBS), media, serum, or in vivo. This can be assessed using radiolabeled active agent.

“Tether” or “tethering agent” or “Linker”, as used herein synonymously, refers to any molecule, or set of molecules, or polymer used to covalently immobilize one or more non-fouling materials, one or more bioactive agents, or combinations thereof on a material where the molecule remains as part of the final chemical composition. The tether can be either linear or branched with one or more sites for immobilizing bioactive agents. The tether can be any length. However, in one embodiment, the tether is greater than 3 angstroms in length. The tether may be non-fouling, such as a monomer, oligomer, or polymer or a non-fouling non-zwitterionic material. The tether may be immobilized directly on the substrate or on a polymer, either of which may be non-fouling.

“Non-naturally occurring amino acid”, as used herein, refers to any amino acid that is not found in nature. Non-natural amino acids include any D-amino acids, amino acids with side chains that are not found in nature, and peptidomimetics. Examples of peptidomimetics include, but are not limited to, b-peptides, g-peptides, and d-peptides; oligomers having backbones which can adopt helical or sheet conformations, such as compounds having backbones utilizing bipyridine segments, compounds having backbones utilizing solvophobic interactions, compounds having backbones utilizing side chain interactions, compounds having backbones utilizing hydrogen bonding interactions, and compounds having backbones utilizing metal coordination. All of the amino acids in the human body, except glycine, exist as the D and L fowls. Nearly all of the amino acids occurring in nature are the L-forms. D-forms of the amino acids are not found in the proteins of higher organisms, but are present in some lower forms of life, such as in the cell walls of bacteria. They also are found in some antibiotics, among them, streptomycin, actinomycin, bacitracin, and tetracycline. These antibiotics can kill bacterial cells by interfering with the formation of proteins necessary for viability and reproduction. Non-naturally occurring amino acids also include residues, which have side chains that resist non-specific protein adsorption, which may be designed to enhance the presentation of the antimicrobial peptide in biological fluids, and/or polymerizable side chains, which enable the synthesis of polymer brushes using the non-natural amino acid residues within the peptides as monomeric units.

“Polypeptide”, “peptide”, and “oligopeptide” encompasses organic compounds composed of amino acids, whether natural, synthetic or mixtures thereof, that are linked together chemically by peptide bonds. Peptides typically contain 3 or more amino acids, preferably more than 9 and less than 150, more preferably less than 100, and most preferably between 9 and 51 amino acids. The polypeptides can be “exogenous,” or “heterologous,” i.e. production of peptides within an organism or cell that are not native to that organism or cell, such as human polypeptide produced by a bacterial cell. Exogenous also refers to substances that are not native to the cells and are added to the cells, as compared to endogenous materials, which are produced by the cells. The peptide bond involves a single covalent link between the carboxyl group (oxygen-bearing carbon) of one amino acid and the amino nitrogen of a second amino acid. Small peptides with fewer than about ten constituent amino acids are typically called oligopeptides, and peptides with more than ten amino acids are termed polypeptides. Compounds with molecular weights of more than 10,000 Daltons (50-100 amino acids) are usually termed proteins.

“Photoactivatable”, as used herein, refers to the ability of certain compounds or moieties of those compounds to become chemically reactive or capable of covalently bonding to molecules upon exposure to light (i.e., ultraviolet light) in a particular frequency range. The frequency range or the type of light however is not limited. Examples of photoactivatable groups include the copolymers exemplified herein, as well as other materials with which the art will be familiar.

“Polar group” as used herein refers, to a substituent or an atomic group that has an electric dipole or multipole moment. Polar groups useful with the compounds and methods disclosed herein include, but are not limited to halogens (F, Cl, Br, I), nitriles (CN), hydroxyl (OH), carboxylic acids (COOH), and carbonyls (CO), sulfonates (SO₃), or nitro groups (NO₂).

“Derivative” as used herein, refers to compounds that are derived from a target compound or a compound that is similar to the target compound such that the compound may be considered a structural or chemical analog of the target compound. Derivatives may have the same basic carbon skeleton and functionality as the target compound, but may include different functional groups or substituents. For example, aryl ketone derivatives include compounds such as benzophenone, thioxanthone and other compounds which are considered as Norrish type II photoinitiators.

“Aryl” as used herein refers to an organic moiety derived from an aromatic hydrocarbon consisting of a ring containing 6 to 10 carbon atoms, by removal of one hydrogen atom. Aryl can be substituted by halogen atoms, sulfonyl C₁₋₆ alkyl groups, sulfoxide C₁₋₆ alkyl groups, sulfonamide groups, carboxcyclic acid groups, C₁₋₆ alkyl carboxylates (ester) groups, amide groups, nitro groups, cyano groups, —OC₁₋₆ alkyl groups, —SC₁₋₆ alkyl groups, —C₁₋₆ alkyl groups, —C₂₋₆ alkenyl groups, —C₂₋₆ alkynyl groups, ketone groups, aldehydes, alkylamino groups, amino groups, aryl groups, C₃₋₈ cycloalkyl groups or hydroxyl groups. Aryls can be monocyclic or polycyclic. Examples of “aryl” groups include, but are not limited to, phenyl, naphthyl, tetrahydronaphthyl, biphenyl, indanyl, anthracyl or phenanthryl, as well as substituted derivatives thereof.

The term “ketone” as used herein, represents an organic compound having a carbonyl group linked to a carbon atom such as —(CO)R^{x} wherein Rx can be alkyl, aryl, cycloalkyl, cycloalkenyl, heterocycle as defined above.

The term “hydrocarbyl” as used herein refers to the monovalent moiety obtained upon removal of a hydrogen atom from a parent hydrocarbon. Representative of hydrocarbyl are alkyl of 1 to 25 carbon atoms, inclusive such as methyl, ethyl, propyl, butyl, pentyl, hexyl, heptyl, octyl, nonyl, undecyl, decyl, dodecyl, octadecyl, nonadecyl eicosyl, heneicosyl, docosyl, tricosyl, tetracosyl, pentacosyl and the isomeric forms thereof; aryl of 6 to 25 carbon atoms, inclusive, such as phenyl, tolyl, xylyl, napthyl, biphenyl, tetraphenyl and the like; aralkyl of 7 to 25 carbon atoms, inclusive, such as benzyl, phenethyl, phenpropyl, phenbutyl, phenhexyl, naphthoctyl and the like; cycloalkyl of 3 to 8 carbon atoms, inclusive, such as cyclopropyl, cyclobutyl, cyclopentyl, cyclohexyl, cycloheptyl, cyclooctyl and the like.

“Antimicrobial peptide” (“AmP”), as used herein, refers to oligopeptides, polypeptides, or peptidomimetics that kill (i.e., are bactericidal) or inhibit the growth of (i.e., are bacteristatic) microorganisms including bacteria, yeast, fungi, mycoplasma, viruses or virus infected cells, and/or protozoa.

“Coupling agent”, as used herein, refers to any molecule or chemical substance which activates a chemical moiety, for example on a bioactive agent or on the material to which it will be attached, to allow for formation of a covalent or non-covalent bond between the bioactive agent and the material to which it will be attached, wherein the material does not remain in the final composition after attachment.

“Cysteine”, as used herein, refers to the amino acid cysteine or a synthetic analogue thereof, wherein the analogue contains a free sulfhydryl group.

“Membrane-targeting antimicrobial agent”, as used herein, refers to any antimicrobial agent that retains its bactericidal or bacteriostatic activity when immobilized on a substrate and can therefore be used to create an immobilized antimicrobial surface. In one embodiment, the membrane-targeting antimicrobial agent is an antimicrobial peptide, and in another embodiment it is a quaternary ammonium compound or polymer. “Immobilized bactericidal activity” as used herein, refers to the reduction in viable microorganisms including bacteria, yeast, fungi, mycoplasma, viruses or virus infected cells, and/or protozoa that contact the surface. For bacterial targets, bactericidal activity may be quantified as the reduction of viable bacteria based on the ASTM 2149 assay for immobilized antimicrobials, which may be scaled down for small samples as follows: an overnight culture of a target bacteria in a growth medium such as Cation Adjusted Mueller Hinton Broth, is diluted to approximately 1×105 cfu/ml in pH 7.4 Phosphate Buffered Saline using a predetermined calibration between OD600 and cell density. A 0.5 cm2 sample of immobilized antimicrobial surface is added to 0.75 ml of the bacterial suspension. The sample should be covered by the liquid and should be incubated at 37° C. with a sufficient amount of mixing that the solid surface is seen to rotate through the liquid. After 1 hour of incubation, serial dilutions of the bacterial suspension are plated on agar plates and allowed to grow overnight for quantifying the viable cell concentration. Preferably at least a 1, 2, 3 or 4 log reduction in bacterial count occurs relative to a control of bacteria in phosphate buffered saline (PBS) without a solid sample.

The term “alkyl” refers to the radical of saturated or unsaturated aliphatic groups, including straight-chain alkyl, alkene, and alkyne groups, branched alkyl, alkene, or alkyne groups, cycloalkyl (alicyclic), cycloalkene, and cycloalkyne groups, alkyl, alkene, or alkyne substituted cycloalkyl, cycloalkene, or cycloalkyne groups, and cycloalkyl substituted alkyl, alkene, or alkyne groups. In preferred embodiments, a straight chain or branched chain alkyl has 30 or fewer carbon atoms in its backbone (e.g., C1-C30 for straight chain, C3-C30 for branched chain), preferably 20 or fewer carbons, more preferably less than 10 carbons atoms, most preferably less than 7 carbon atoms. Likewise, preferred cycloalkyls have from 3-10 carbon atoms in their ring structure, and more preferably have 5, 6 or 7 carbons in the ring structure.

It will be understood that “substitution” or “substituted” includes the implicit proviso that such substitution is in accordance with permitted valence of the substituted atom and the substituent, and that the substitution results in a stable compound, e.g., which does not spontaneously undergo transformation such as by rearrangement, cyclization, elimination, etc.

As used herein, the term “substituted” is contemplated to include all permissible substituents of organic compounds. In a broad aspect, the permissible substituents include acyclic and cyclic, branched and unbranched, carbocyclic and heterocyclic, aromatic and nonaromatic substituents of organic compounds. Illustrative substituents include, but are not limited to, aryl, heteroaryl, hydroxyl, halogen, alkoxy, nitro, sulfhydryl, sulfonyl, amino (substituted and unsubstituted), acylamino, amido, alkylthio, carbonyl groups, such as esters, ketones, aldehydes, and carboxylic acids; thiocarbonyl groups, sultanate, sulfate, sulfinylamino, sulfamoyl, and sulfoxido.

The permissible substituents can be one or more and the same or different for appropriate organic compounds. For purposes of this invention, the heteroatoms such as nitrogen may have hydrogen substituents and/or any permissible substituents of organic compounds described herein which satisfy the valences of the heteroatoms. This polymers described herein are not intended to be limited in any manner by the permissible substituents of organic compounds.

### DETAILED DESCRIPTION

Disclosed herein are novel photoactivatable copolymers that are composed of a photoactivatable monomer that includes an aryl ketone derivative having one or more polar groups or alkyl groups and a hydrophilic monomer. Disclosed herein too are methods of making the photoactivatable copolymers, coating compositions comprising the copolymers, and articles coated with the copolymer.

Advantageously, the photoactivatable copolymers disclosed herein are highly soluble in comparison with other known photoactivatable polymers. In particular, the presence of the polar group or alkyl group on the photoactivatable monomer in combination with the hydrophilic monomer creates a highly soluble copolymer without adversely affecting the stability or photoactivity of the copolymer. The present copolymers produce coatings for a wide variety of substrates that are more homogeneous and use simple coating processes. The increased solubility of the copolymers disclosed herein overcomes the difficulties that are associated with surface modification using known photoactivatable copolymers, such as non-homogenous coatings, complex coating processes, and weak attachment of the coating to the substrate.

The photoactivatable copolymers are designed for application to a substrate and for activation by light energy to form an anti-fouling hydration layer with highly bound water that is the equivalent to polymer brushes. These photoactivatable copolymers can effectively generate an anti-fouling layer by using hydrophilic moieties such as betaines and aryl ketone derivatives such as benzophenone.

When light energy is applied to the copolymer, the aryl ketone derivative of the copolymer activates to form radical groups. The radical groups formed in the copolymer then react with functional groups on the substrate surface to covalently bond the copolymer to the surface. The photoactivation of the copolymer may be performed using visible light or ultraviolet light and is not limited in this regard.

The copolymers disclosed herein also have superior fouling-resistant properties, making them particularly useful as coatings for medical devices. These coatings have proven to be highly stable and functional. As set forth in further detail below, the copolymers have demonstrated high reductions in protein adsorption for surfaces that have been modified with the photoactivatable copolymers disclosed herein. In some aspects, the copolymers may also possess anti-thrombotic and/or antimicrobial properties.

The copolymers disclosed herein may be random copolymers or block copolymers. In some aspects of the present disclosure, the photoactivatable copolymer may have a weight average molecular weight ranging from 5,000 to 200,000 Daltons, particularly from 30,000 to 150,000 Daltons.

Photoactivatable Monomer

The photoactivatable monomer may be present in the copolymer in an amount of 0.1% to 70% by weight based on the total weight of the copolymer, and particularly from 0.1 to 20% by weight % based on the total weight of the copolymer. The photoactivatable monomer may have an average molecular weight ranging from 5,000 to 200,000 Daltons, particularly from 30,000 to 150,000 Daltons.

The copolymers disclosed herein include a photoactivatable monomer, which comprises an aryl ketone derivative. In some aspects of the disclosure, the aryl ketone derivative may for example, include one of the following groups, functionalities or radicals: benzophenone-, acetophenone-, benzyl-, benzoin-, hydroxyalkylphenone-, phenyl cyclohexyl ketone-, anthraquinone-, trimethyl-benzoylphosphine oxide-, methylthiophenyl morpholine ketone-, aminoketone-, azobenzoin-, thioxanthone-, hexaarylbisimidazole-, triazine-, or fluoroenone-. In several embodiments, the photoactivatable monomer includes a benzophenone group. In some aspects of the present disclosure, the photoactivatable monomer is preferably benzophenone.

The aryl ketone derivative may include a polar group or alkyl group. In some aspects of the disclosure, the polar or alkyl group may be carboxylic acid, a sulfonate group, or a nitro group. Other functional groups, however, may be used.

In some aspects of the present disclosure, the photoactivatable monomer includes at least one unsaturated group. Suitable unsaturated groups in the photoactivatable monomer may include, but are not limited to methacrylate, acrylate, acrylamide, vinyl group or mixtures thereof.

In yet other aspects of the present disclosure, the photoactivatable monomer is an aryl ketone derivative including at least one unsaturated group. Suitable unsaturated groups for the aryl ketone derivative may include, but are not limited to methacrylate, acrylate, acrylamide, vinyl group or mixtures thereof.

The present disclosure is directed to photoactivatable copolymers formed from a photoactivatable monomer. In one aspect, an example of a photoactivatable monomer according to the present disclosure is shown below:

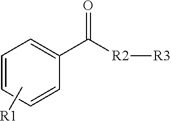

wherein R1 represents one or more polar groups, alkyl groups or a mixture thereof; R2 represents substituted aryl groups, substituted hydroxyalkyl groups, substituted alkyl groups, or a mixture thereof; and R3 represents an unsaturated group.

In another aspect, an example of a photoactivatable monomer according to the present disclosure is shown below:

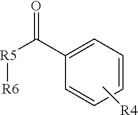

wherein R4 represents one or more polar groups, alkyl groups, or a mixture thereof; R5 represents substituted aryl groups, substituted hydroxyalkyl groups, substituted alkyl groups, or a mixture thereof; and R6 represents an unsaturated group.

In another aspect, an example of a photoactivatable monomer according to the present disclosure is shown below:

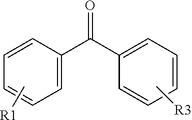

wherein R1 represents one or more polar groups, alkyl groups or a mixture thereof, and R3 represents an unsaturated group.

Additional examples of photoactivatable monomers suitable for use in the copolymers disclosed herein are shown below:

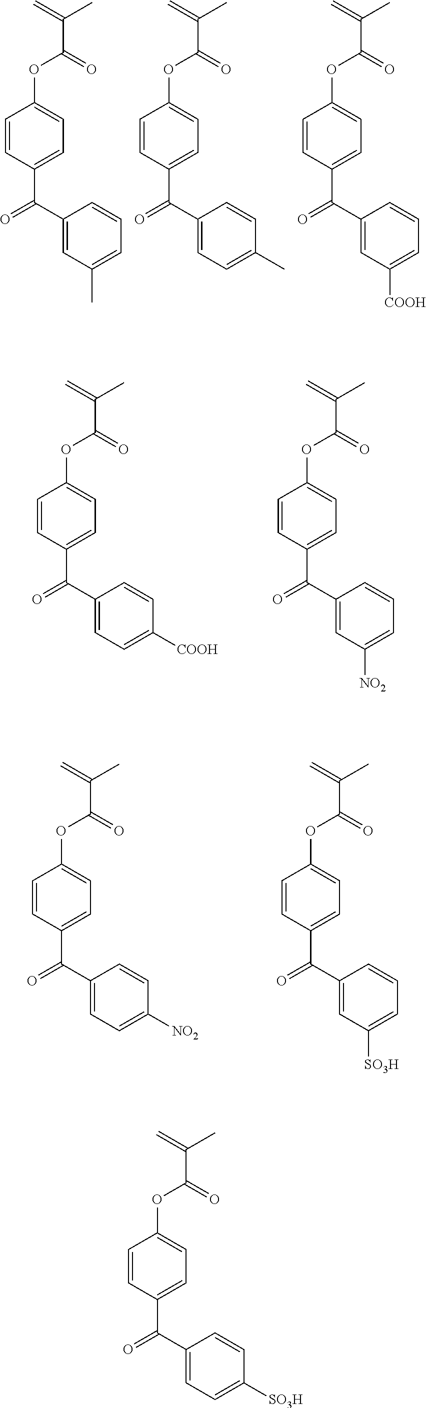

In some aspects, the photoactivatable monomer will preferably be water-soluble thereby providing a homogenous solution for dip-coating the copolymer onto a substrate surface. In yet other aspects, the polar groups will improve water solubility and lower the charge-transfer state of the aryl ketone derivative. The lowered charge-transfer state of the aryl ketone derivative will ultimately cause the benzophenone to be more reactive when the copolymer is exposed to UV light.

Hydrophilic Monomer

The photoactivatable copolymer includes a hydrophilic monomer in addition to the photoactivatable monomer. The hydrophilic monomer is not limited and may include any polymer having a hydrophilic moiety. Hydrophilic polymers know to be suitable as hydrophilic coatings may be particularly useful. In some aspects of the present disclosure, the hydrophilic monomer may be responsible for imparting the anti-fouling properties to the copolymer.

The hydrophilic monomer may be present in an amount of 30 to 99.9% by weight based on the total weight of the copolymer, and particularly ranging from 70-90% by weight based on the total weight of the copolymer. The hydrophilic monomer may have an average molecular weight ranging from 5,000 to 200,000 Daltons, particularly from 30,000 to 200,000 Daltons.

In some aspects of the present disclosure, the hydrophilic monomer may include a chain growth addition polymer such as a polyolefin. In one aspect, the hydrophilic monomer includes at least one unsaturated group.

Preferably, the hydrophilic monomer includes a zwitterionic molecule. Zwitterions are molecules that carry formal positive and negative charges on non-adjacent atoms within the same molecule and molecules that may be ionized by addition or removal of an electrophile or a nucleophile, or by removal of a protecting group. Both natural and synthetic polymers, containing zwitterion functionality, have been shown to resist protein adhesion. In one embodiment, the zwitterionic monomer contains a phosphorylcholine moiety, a carboxyammonium moiety, a sulfoammonium moiety, derivatives thereof, or combinations thereof. In one embodiment, the zwitterionic monomer contains a carboxyammonium moiety, a sulfoammonium moiety, derivatives thereof, or combinations thereof. In one embodiment, the zwitterionic monomer contains a sulfobetaine moiety or a carboxybetaine moiety. The zwitterionic polymer may be formed by initiating polymerization with radicals present in the polymeric substrate, in the presence of one or more monomers, such as sulfobetaine methacrylate or carboxybetaine methacrylate monomers.

Polysulfoammonium polymers such as polysulfobetaines, polycarboxyammonium polymers such as polycarboxybetaines and other natural and synthetic zwitterion chemistries can be used to design non-fouling materials for the biomedical applications described herein. Some examples of natural zwitterions chemistries that could be used for non-fouling materials include, but are not limited to, amino acids, peptides, natural small molecules including, but not limited to, N,N,N-trimethylglycine (glycine betaine), trimethylamine oxide (TMAO), dimethylsulfoniopropionate sarcosine, lysergic acid and psilocybin. Additional synthetic zwitterions that could be used to create non-fouling materials, include, but are not limited to, amino-carboxylic acids (carboxybetaines), amino-sulfonic acids (sulfo betaines), cocamidopropyl betaine, quinonoid based zwitterions, decaphenylferrocene, and non-natural amino acids. Natural and synthetic polymers also include mixed charged structures with both positive charged and negative charged moieties on the pendant groups, in the main chains, or at the terminal groups.

Materials containing, or composed of, these natural or synthetic zwitterions, can be applied on surfaces, particularly the surfaces of medical devices, in order to improve biocompatibility, reduce thrombogenesis (such as on the surface of stents or venous valves), and reduce fouling by proteins or bacteria present in solution. This is particularly applicable for surfaces where non-specific binding of proteins in solution could negatively impact the desired or necessary mechanics of a device.

In one embodiment, the non-fouling polymer contains zwitterionic pendant groups covalently attached, directly or indirectly to the polymer back bone. The zwitterionic pendant groups may have an overall net charge, for instance, by having a divalent center of anionic charge and monovalent center of cationic charge or vice versa, or by having two centers of cationic charge and one center of anionic charge or vice versa. Preferably, however, the zwitterion has no overall net charge and most preferably has a center of monovalent cationic charge and a center of monovalent anionic charge. Additionally, the center(s) of cationic charge are preferably permanent; that is, it is preferably a quaternary nitrogen, quaternary phosphonium or tertiary sulfonium group. Additionally, the center(s) of anionic charge are also permanent; that is, they are completely ionized at physiological pH and are preferably carboxylate, phosphate, phosphonic, phosphonate, sulfate, sulfinic, or sulfonate.

In another embodiment, the polymer contains zwitterionic pendant groups covalently attached, directly or indirectly, to the polymer back bone, and the zwitterion corresponds to Formula ZI-3:

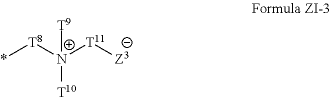

wherein T⁸ is a bond, hydrocarbylene, substituted hydrocarbylene, heterocyclo, or in combination with T⁹ and T¹⁰ and the nitrogen atom to which they are attached form a nitrogen-containing heteroaromatic ring,
T⁹ and T¹⁰ are independently hydrogen, hydrocarbyl, substituted hydrocarbyl or heterocyclo, or, T⁹ and T¹⁰, in combination with T⁸ and the nitrogen atom to which they are attached form a nitrogen-containing heteroaromatic ring,
T¹¹ is hydrocarbylene, substituted hydrocarbylene, ether, or oxylated alkylene,
Z³ is carboxylate, phosphate, phosphonic, phosphonate, sulfate, sulfinic, or sulfonate, and
* designates the point of covalent attachment, direct or indirect, of the zwitterion of Formula ZI-3 to the polymer backbone.

In certain preferred embodiments in which the polymer contains zwitterionic pendant group corresponding to Formula ZI-3, T⁸, T⁹, T¹⁰, and T¹¹ are selected from a more narrow range of substituents, Z³ is carboxylate or sulfate, and the zwitterion corresponds to Formula ZI-4:

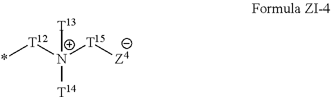

wherein * designates the point of covalent attachment, direct or indirect, of the zwitterion of Formula ZI-4 to the polymer backbone; T¹² is a bond or —(CH₂)ₘ— with m being 1 to 3; T¹³ and T¹⁴ are independently hydrogen, alkyl, or substituted alkyl; T¹⁵ is optionally substituted alkylene, phenylene, ether, or oxylated alkylene; and Z⁴ is carboxylate or sulfate. For example, in this embodiment, T¹³ and T¹⁴ may independently be hydrogen or lower alkyl, e.g., methyl, ethyl, or propyl. By way of further example, in this embodiment, T¹³ and T¹⁴ may independently be hydrogen or lower alkyl, e.g., methyl, ethyl, or propyl. By way of further example, in this embodiment, T¹⁵ may be —(CH₂)ₙ— with n being 1-8. By way of further example, in this embodiment, T¹⁵ may be —(CH₂)₂— or —(CH₂)₃— and T¹³ and T¹⁴ may be methyl. By way of further example, in this embodiment, T¹⁵ may be —(CH₂)₂— or —(CH₂)₃—, T¹³ and T¹⁴ may be hydrogen or alkyl. By way of further example, in this embodiment, T¹² may be —(CH₂)₂—, T¹³ and T¹⁴ may be methyl, T¹⁵ may be —(CH₂)₂— and Z⁴ may be carboxylate. By way of further example, in this embodiment, T¹² may be —(CH₂)₂—, T¹³ and T¹⁴ may be methyl, T¹⁵ may be —(CH₂)₃— and Z⁴ may be sulfate.

In certain preferred embodiments in which the polymer contains zwitterionic pendant group corresponding to Formula ZI-3, T⁸, T⁹ and T¹⁰ and the nitrogen atom to which they are attached form a nitrogen-containing heteroaromatic ring. For example, T⁸, T⁹ and T¹⁰ and the nitrogen atom to which they are attached may form an optionally substituted heterocycle, containing a quaternary nitrogen atom. One such embodiment corresponds to Formula ZI-5:

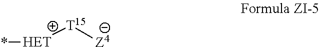

wherein * designates the point of covalent attachment, direct or indirect, of the zwitterion of Formula ZI-5 to the polymer backbone; HET is a heterocycle containing a quaternary nitrogen atom, T¹⁵ is optionally substituted alkylene, phenylene, ether, or oxylated alkylene; and Z⁴ is carboxylate or sulfate. For example, in this embodiment, T¹⁵ may be —(CH₂)ₙ— with n being 1-8. By way of further example, in this embodiment, T¹⁵ may
be —(CH₂)₂— or —(CH₂)₃— and Z⁴ may be carboxylate or sulfate. By way of further example, in this embodiment, T¹⁵ may be —(CH₂)₃— and Z⁴ may be sulfate. By way of further example, in this embodiment, T¹⁵ may be —(CH₂)₂— and Z⁴ may be carboxylate. Exemplary zwitterions corresponding to Formula ZI-5 include zwitterions corresponding to Formulae ZI-6A and ZI-6B:

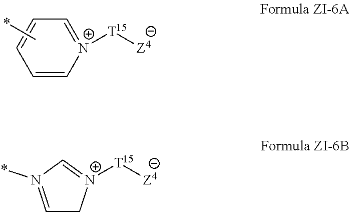

wherein * designates the point of covalent attachment, direct or indirect, of the zwitterion of Formulae ZI-6A and ZI-6B to the polymer backbone; T¹⁵ is optionally substituted alkylene, phenylene, ether, or oxylated alkylene; and Z⁴ is carboxylate or sulfate. For example, in this embodiment, T¹⁵ may be —(CH₂)ₙ— with n being 1-8. By way of further example, in this embodiment, T¹⁵ may be —(CH₂)₂— or —(CH₂)₃— and Z⁴ may be carboxylate or sulfate. By way of further example, in this embodiment, T¹⁵ may be —(CH₂)₃— and Z⁴ may be sulfate. By way of further example, in this embodiment, T¹⁵ may be —(CH₂)₂— and Z⁴ may be carboxylate.

In one embodiment, the polymer contains zwitterionic pendant groups covalently attached, directly or indirectly, to the polymer back bone, and the zwitterion corresponds to Formula ZI-7

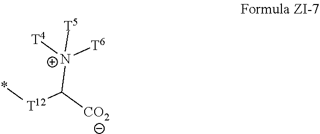

wherein T⁴, T⁵ and T⁶ are independently hydrogen, hydrocarbyl, substituted hydrocarbyl or heterocyclo; T¹² is a bond, hydrocarbylene, substituted hydrocarbylene, or heterocyclo, and * designates the point of covalent attachment, direct or indirect, of the zwitterion of Formula ZI-7 to the polymer backbone.

In one embodiment, the polymer contains zwitterionic pendant groups covalently attached, directly or indirectly, to the polymer back bone, and the zwitterion corresponds to Formula ZI-1:

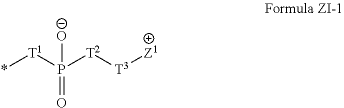

wherein T¹ and T² are independently oxygen, sulfur, NH or a bond,
T³ is hydrocarbylene, substituted hydrocarbylene, ether, or oxylated alkylene,
Z¹ is a moiety comprising a quaternary nitrogen, phosphonium or sulfonium cationic group, and
* designates the point of covalent attachment, direct or indirect, of the zwitterion of Formula ZI-1 to the polymer backbone.

In certain preferred embodiments in which the polymer contains zwitterionic pendant group corresponding to Formula ZI-1, T¹ and T² are oxygen, Z¹ is quaternary nitrogen, and the zwitterion corresponds to Formula ZI-2:

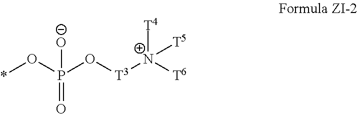

wherein * designates the point of covalent attachment of the zwitterion of Formula ZI-2 to the polymer backbone, T³ is hydrocarbylene, substituted hydrocarbylene, or oxylated alkylene, and T⁴, T⁵ and T⁶ are independently hydrogen, hydrocarbyl, substituted hydrocarbyl or heterocyclo. For example, in this embodiment, T³ may be —(CH₂)ₙ— with n being 1-8. By way of further example, in this embodiment, T⁴, T⁵ and T⁶ may independently be lower alkyl, e.g., methyl, ethyl or propyl. By way of further example, in this embodiment, T³ may be —(CH₂)ₙ— with n being 1-3, and T⁴, T⁵ and T⁶ may independently be lower alkyl, e.g., methyl, ethyl or propyl. By way of further example, in this embodiment, T³ may be —(CH₂)ₙ— with n being 1-3, and one or more of T⁴, T⁵ and T⁶ may be substituted hydrocarbyl such as oligomeric phosphorylcholine (e.g., Formula 9).

Neutral Hydrophilic Pendant Groups

In one embodiment, the polymer contains neutral hydrophilic pendant groups covalently attached, directly or indirectly, to the polymer backbone. Exemplary neutral hydrophilic groups include hydroxy, thiol, oxylated alkyls (e.g., oligoethylene glycol, polyethylene glycol and/or polypropylene glycol), ether, thioether, and the like. In one such specific embodiment, the polymer contains pendant groups comprising alkoxylated moieties corresponding to Formula POA-1:

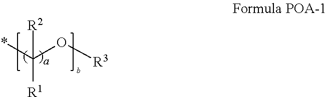

wherein a is 1-3, b is 1-8, each R¹ and R² is independently selected from the group consisting of hydrogen, halogen, and optionally substituted lower alkyl, R³ is hydrocarbyl, substituted hydrocarbyl or heterocyclo, and * designates the point of attachment of the moieties corresponding to Formula POA-1 to the remainder of the pendant group and the backbone. By way of example, in one such embodiment, each R¹ and R² are hydrogen, n is 2 or 3. By way of further example, in one such embodiment, each R¹ and R² is hydrogen, n is 2 or 3, and b is 3-5. By way of further example, in one such embodiment, each R¹ and R² is hydrogen, n is 2 or 3, b is 3-5, and R³ is alkyl. In one embodiment, the repeat units are derived from macromonomers containing 2-20 alkylene oxide units.

In one embodiment, the polymer contains hydrophilic group contains peptides, poly(2-oxazoline)s, or alkoxy groups.

Repeat Units

In general, homopolymers or copolymers comprising zwitterionic pendant groups, neutral hydrophilic pendant groups, cationic pendant groups and/or anionic pendant groups may be prepared by polymerization of any of a wide range of monomers. In one preferred embodiment, the non-fouling polymeric material is a homopolymer or copolymer comprising repeat units derived from an olefinic monomer. Thus, for example, in one embodiment the non-fouling polymeric material comprises repeat units derived from an olefinic monomer and corresponding to Formula 1:

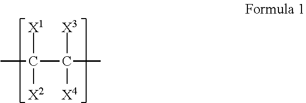

wherein X¹ and X² are independently hydrogen, hydrocarbyl, substituted hydrocarbyl, heterocyclo, or substituted carbonyl, provided, however, X¹ and X² are not each selected from the group consisting of aryl, heteroaryl, and heterosubstituted carbonyl,
X³ is hydrogen, alkyl or substituted alkyl,
X⁴ is —OX⁴⁰, —NX⁴¹X⁴², —NX⁴¹X⁴²X⁴³, —SX⁴⁰, aryl, heteroaryl or acyl,
X⁴⁰ is hydrogen, hydrocarbyl, substituted hydrocarbyl, heterocyclo or acyl, and
X⁴¹, X⁴² and X⁴³ are independently hydrogen, hydrocarbyl, substituted hydrocarbyl or heterocyclo.

In certain embodiments in which the non-fouling polymeric material comprises repeat units corresponding to Formula 1, it is preferred that X⁴ of at least a fraction of the repeat units comprise alkoxylated moieties, zwitterionic moieties, anionic moieties, or cationic moieties. In such embodiments, for example, X¹ and X² may be hydrogen, and the polymer comprises repeat units corresponding to Formula 2:

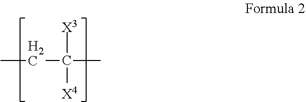

wherein X³ is hydrogen, alkyl or substituted alkyl, and X⁴ is a pendant group comprising an oxylated alkylene moiety, a zwitterionic moiety, an anionic moiety, or a cationic moiety. For example, X³ may be hydrogen or lower alkyl. By way of further example, X⁴ may be a pendant group comprising an oxylated alkylene moiety corresponding to Formula POA-1. By way of further example, the repeat unit of Formula 2 may be zwitterionic repeat unit comprising a zwitterionic moiety corresponding to Formula ZI-1, ZI-2, ZI-3, ZI-4, ZI-5, ZI-6A, ZI-6B, or ZI-7. By way of further example, the repeat unit of Formula 2 may be a cationic repeat unit. By way of further example, the repeat unit of Formula 2 may be an anionic repeat unit. By way of further example, X³ may be hydrogen or methyl and X⁴ may be a pendant group comprising an oxylated alkylene moiety corresponding to Formula POA-1 or a zwitterionic moiety corresponding to Formula ZI-1, ZI-2, ZI-3, ZI-4, ZI-5, ZI-6A, ZI-6B, or ZI-7.

In one presently preferred embodiment, the non-fouling polymeric material comprises repeat units corresponding to Formula 2 wherein X⁴ is acyl and the repeat units correspond to Formula 3:

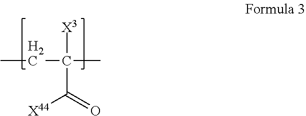

wherein X⁴⁴ comprises an oxylated alkylene moiety, a zwitterionic moiety, an anionic moiety, or a cationic moiety. For example, X⁴⁴ may be —OX⁴⁵, —NX⁴⁵X⁴⁶ or —SX⁴⁵′, wherein X⁴⁵ is a substituted hydrocarbyl or heterocyclo moiety comprising an oxylated alkylene moiety, a zwitterionic moiety, an anionic moiety, or a cationic moiety, and X⁴⁶ is hydrogen, hydrocarbyl, substituted hydrocarbyl or heterocyclo. For example, X³ may be hydrogen or lower alkyl. By way of further example, X⁴⁴ may be —OX⁴³, or —NHX⁴⁵. By way of further example, X⁴⁴ may be —OX⁴⁵, or —NHX⁴⁵ wherein X⁴⁵ comprises an oxylated alkylene moiety corresponding to Formula POA-1. By way of further example, X⁴⁴ may be —OX⁴⁵, or —NHX⁴⁵ wherein X⁴⁵ comprises a zwitterionic moiety corresponding to Formula ZI-1, ZI-2, ZI-3, ZI-4, ZI-5, ZI-6A, ZI-6B, or ZI-7. By way of further example, the repeat unit of Formula 3 may be a cationic repeat unit. By way of further example, the repeat unit of Formula 3 may be an anionic repeat unit. By way of further example, X³ may be hydrogen or methyl and X⁴⁴ may comprise an oxylated alkylene moiety corresponding to Formula POA-1 or a zwitterionic moiety corresponding to Formula ZI-1, ZI-2, ZI-3, ZI-4, ZI-5, ZI-6A, ZI-6B, or ZI-7. In one particularly preferred embodiment, the polymer contains repeat units corresponding to Formula 3 and X⁴⁴ is —O(CH₂)₂N⁺(CH₃)₂(CH₂)SO₃⁻, —O(CH₂)₂N⁺(CH₃)₂(CH₂)ₙCO₂⁻, —NH(CH₂)₃N⁺(CH₃)₂(CH₂)ₙCO₂⁻,
or —NH(CH₂)₃N⁺(CH₃)₂(CH₂)ₙSO₃⁻, wherein n is 1-8. In one embodiment, the polymer contains repeat units corresponding to Formula 3 and X⁴⁴
is —NH(CH₂)ₘN(CH₂)ₙCH₃(CH₂)ₚSO₃, —NH(CH₂)ₘN(CH₂)ₙCH₃(CH₂)ₚCO₂, —NH(CH₂)ₘN⁺[(CH₂)ₙCH₃]₂(CH₂)ₚSO₃, —NH(CH₂)N⁺[(CH₂)CH₃]₂(CH₂)ₚCO₂, —NH(CH₂)ₘNcyclo-(CH₂)ₚCO₂ or —NH(CH₂)ₘNcyclo-(CH₂)ₚSO₃, (Ncyclo is a heterocyclic structure or a heterocyclic derivative containing at least one nitrogen element), wherein m is 1-8; n is 0-5; and p is 1-8. In one embodiment, the polymer contains repeat units corresponding to Formula 3 and X⁴⁴
is —O(CH₂)ₘN(CH₂)ₙCH₃(CH₂)ₚSO₃, —O(CH₂)ₘN(CH₂)ₙCH₃(CH₂)ₚCO₂, —O(CH₂)ₘN+[(CH₂)ₙ CH₃]₂(CH₂)ₚSO₃, —O(CH₂)N⁺[(CH₂)CH₃]₂ (CH₂)ₚCO₂, —O(CH₂)ₘNcyclo-(CH₂)ₚCO₂, or —O(CH₂)ₘNcyclo-(CH₂)ₚSO₃ wherein m is 1-8; n is 0-5; and p is 1-8. In one embodiment, the polymer contains repeat units corresponding to Formula 3 and X⁴⁴ is —O(CH₂)₂N⁺(CH₃)₂(CH₂)₃SO₃, —O(CH₂)₂N⁺(CH₃)₂(CH₂)₂CO₂, —NH(CH₂)₂N⁺(CH₃)₂(CH₂)₃SO₃, —NH(CH₂)₂N⁺(CH₃)₂(CH₂)₂CO₂, —NH(CH₂)₃N⁺(CH₃)₂(CH₂)₃SO₃, —NH(CH₂)₃N⁺(CH₃)₂(CH₂)₂CO₂, —O(CH₂)₂N⁺(CH₂CH₃)₂(CH₂)₃SO₃, —O(CH₂)₂N⁺(CH₂CH₃)₂(CH₂)₂CO₂, —O(CH₂)₂N⁺(CH₂CH₂CH₂CH₃)₂(CH₂)₃SO₃, —O(CH₂)₂N⁺(CH₂CH₂CH₂CH₃)₂(CH₂)₂CO₂ or —NH(CH₂)₃Ncyclo-(CH₂)₃SO₃.

In one preferred embodiment, the non-fouling polymeric material is a zwitterionic polymer or copolymer. For example, the non-fouling polymeric material may comprise carboxybetaine repeat units and/or sulfobetaine repeat units. Alternatively, the non-fouling polymeric material may be a polyampholyte, containing anionic and cationic repeat units. Optionally, the non-fouling polymer may contain poly(ethylene oxide) repeat units and/or other neutral olefinic repeat units. Thus, for example, in one preferred embodiment, the non-fouling polymeric material is a zwitterionic polymer or copolymer comprising the repeat units of Formula 4:

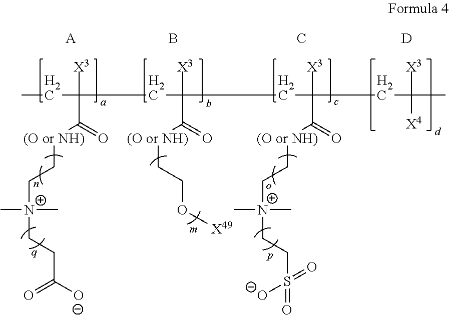

a is 0-1; b is 0-1; c is 0-1; d is 0-1; m is 1-20; n and o are independently 0-11; p and q are independently 0-11; X³ is hydrogen, alkyl or substituted alkyl, X⁴ is —OX⁴⁰, —NX⁴¹X⁴², —SX⁴⁰, aryl, heteroaryl or acyl; X⁴⁰ is hydrogen, hydrocarbyl, substituted hydrocarbyl, heterocyclo or acyl; X⁴¹ and X⁴² are independently hydrogen, hydrocarbyl, substituted hydrocarbyl or heterocyclo; and X⁴⁹ is hydrogen, hydrocarbyl or substituted hydrocarbyl, provided the sum of a, b, c and d is greater than 0 and X⁴ of repeat unit D differs from the corresponding pendant group of repeat units A, B and C. In one such embodiment, X³ is hydroxy-substituted alkyl such as hydroxypropyl.

In certain embodiments, the non-fouling polymeric material is a homopolymer or copolymer comprising repeat units corresponding to Formula 5, Formula 6, Formula 7, Formula 8, or Formula 9:

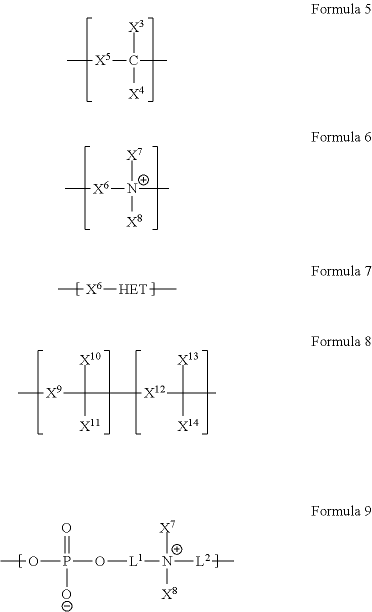

HET is part of a heterocyclic structure,
X³ is hydrogen, alkyl or substituted alkyl,
X⁴ is —OX⁴⁰, —NX⁴¹X⁴², —SX⁴⁰, aryl, heteroaryl or acyl,
X⁵ is ester, anhydride, imide, amide, ether, thioether, thioester, hydrocarbylene, substituted hydrocarbylene, heterocyclo, urethane, or urea;
X⁶ is hydrocarbylene, substituted hydrocarbylene, heterocyclo, amide, anhydride, ester, imide, thioester, thioether, urethane, or urea;
X⁷ is hydrogen, alkyl or substituted alkyl;
X⁸ is an anionic moiety;
X⁹ is hydrocarbylene, substituted hydrocarbylene, heterocyclo, amide, anhydride, ester, imide, thioester, thioether, urethane, or urea;
X¹⁰ is hydrogen, alkyl or substituted alkyl;
X¹¹ is a cationic moiety;
X¹² is hydrocarbylene, substituted hydrocarbylene, heterocyclo, amide, anhydride, ester, imide, thioester, thioether, urethane, or urea;
X¹³ is hydrogen, alkyl or substituted alkyl;
X¹⁴ is an anionic moiety;
L¹ and L² are independently hydrocarbylene, substituted hydrocarbylene, heterocyclo, amide, anhydride, ester, imide, thioester, thioether, urethane, or urea; and
X⁴⁰ is hydrogen, hydrocarbyl, substituted hydrocarbyl, heterocyclo or acyl, and
X⁴¹ and X⁴² are independently hydrogen, hydrocarbyl, substituted hydrocarbyl or heterocyclo.

In one embodiment, the non-fouling polymeric material comprises repeat units corresponding to Formula 7 wherein the heterocycle, HET corresponds to Formulae 10, 11 or 12:

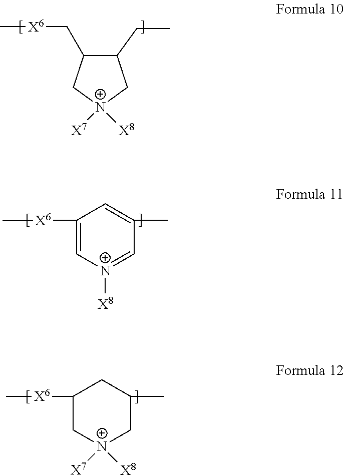

wherein X⁶ is hydrocarbylene, substituted hydrocarbylene, heterocyclo, amide, anhydride, ester, imide, thioester, thioether, urethane, or urea; X⁷ is hydrogen, alkyl or substituted alkyl; and X⁸ is an anionic moiety.

Suitable comonomers include, but are not limited to, acrylates, acrylamides, vinyl compounds, multifunctional molecules, such as di-, tri-, and tetraisocyanates, di-, tri-, and tetraols, di-, tri-, and tetraamines, and di-, tri-, and tetrathiocyanates; cyclic monomers, such as lactones and lactams, and combination thereof. In the interests of brevity, exemplary methacrylate monomers are listed below (but it should be understood that analogous acrylate, acrylamide and methacrylamide monomers may be similarly listed and are similarly included):

Charged methacrylates or methacrylates with primary, secondary or tertiary amine groups, such as, 3-sulfopropyl methacrylate potassium salt, (2-dimethylamino)ethyl methacrylate) methyl chloride quaternary salt, [2-(methacryloyloxy)ethyl]trimethyl-ammonium chloride, methacryloyl chloride, [3-(methacryloylamino)propyl]-trimethylammonium chloride), 2-aminoethyl methacrylate hydrochloride, 2-(diethylamino)ethyl methacrylate, 2-(dimethylamino)ethyl methacrylate, 2-(tert-butylamino)ethyl methacrylate, and 2-(tert-butylamino-ethyl methacrylate.

Alkyl methacrylates or other hydrophobic methacrylates, such as ethyl methacrylate, butyl methacrylate, hexyl methacrylate, 2-ethylhexyl methacrylate, methyl methacrylate, lauryl methacrylate, isobutyl methacrylate, isodecyl methacrylate, phenyl methacrylate, decyl methacrylate, 3,3,5-trimethylcyclohexyl methacrylate, benzyl methacrylate, cyclohexyl methacrylate, stearyl methacrylate, tert-butyl methacrylate, tridecyl methacrylate, 2-naphthyl methacrylate, 2,2,3,3-tetrafluoropropyl methacrylate, 1,1,1,3,3,3-hexafluoroisopropyl methacrylate, 2,2,2-trifluoroethyl methacrylate, 2,2,3,3,3-pentafluoropropyl methacrylate, 2,2,3,4,4,4-hexafluorobutyl methacrylate, 2,2,3,3,4,4,4-heptafluorobutyl methacrylate, 2,2,3,3,4,4,5,5-octafluoropentyl methacrylate, 3,3,4,4,5,5,6,6,7,7,8,8,8-tridecafluorooctyl methacrylate, and 3,3,4,4,5,5,6,6,7,7,8,8,9,9,10,10,10-heptadecafluorodecyl methacrylate.

Reactive or crosslinkable methacrylates, such as 2-(trimethylsilyloxy)ethyl methacrylate, 3-(trichlorosilyl)propyl methacrylate, 3-(trimethoxysilyl)propyl methacrylate, 3-[tris(trimethylsiloxy)silyl]propyl methacrylate, trimethylsilyl methacrylate, allyl methacrylate, vinyl methacrylate, 3-(acryloyloxy)-2-hydroxypropyl methacrylate, 3-(diethoxymethylsilyl)propyl methacrylate 3-(dimethylchlorosilyl)propyl methacrylate 2-isocyanatoethyl methacrylate, glycidyl methacrylate, 2-hydroxyethyl methacrylate, 3-chloro-2-hydroxypropyl methacrylate, Hydroxybutyl methacrylate, glycol methacrylate, hydroxypropyl methacrylate, and 2-hydroxypropyl 2-(methacryloyloxy)ethyl phthalate.

Other methacrylates, such as ethylene glycol methyl ether methacrylate, di(ethylene glycol) methyl ether methacrylate, ethylene glycol phenyl ether methacrylate, 2-butoxyethyl methacrylate, 2-ethoxyethyl methacrylate, and ethylene glycol dicyclopentenyl ether methacrylate.

Multifunctional monomers, such as di, tri, or tetraacrylates and di, tri, or tetraacrylamides can be used to form highly branched structures which can provide a higher concentration of non-fouling groups on the surface. As previously noted, the non-fouling polymeric material may contain a non-zwitterionic non-fouling material, alone or in combination with a zwitterionic material. These non-fouling groups may have varying degrees of non-fouling performance in a range of environments. Suitable non-zwitterionic materials include, but are not limited to, polyethers, such as polyethylene glycol, poly(ethylene oxide-co-propylene oxide) (PEO-PPO) block copolymers, polysaccharides such as dextran, hydrophilic polymers such as polyvinylpyrrolidone (PVP) and hydroxyethyl-methacrylate (HEMA), acrylonitrile-acrylamide copolymers, heparin, heparin fragments, derivatized heparin fragments, hyaluronic acid, mixed charge materials, and materials containing hydrogen bond accepting groups, such as those described in U.S. Pat. No. 7,276,286 (herein incorporated by reference in its entirety). Suitable polymer structures included, but are not limited to, polymers or copolymers containing monomers of Formula I wherein ZI is replaced by a non-zwitterionic, non-fouling head group.

In one embodiment, the non-fouling material is a polymer containing repeat units derived from sulfobetaine-containing and/or carboxybetaine-containing monomers. Examples of monomers include sulfobetaine methacrylate (SBMA), sulfobetaine acrylamide, sulfobetaine methacrylamide, carboxybetaine methacrylate (CBMA), carboxybetaine acrylamide and carboxybetaine methacrylamide. Examples of such polymers include, but are not limited to, poly(carboxy betaine methacrylate) (polyCBMA), poly(carboxybetaine acrylamide), poly(carboxybetaine methacrylamide) poly(sulfobetaine methacrylate) (polySBMA), poly(sulfobetaine acrylamide), and poly(sulfobetaine methacrylamide). In another embodiment, the non-fouling material polymer is a polymer containing the residue of CBMA or SBMA and one or more additional monomers. The additional monomers can be zwitterionic or non-zwitterionic monomers.

In some embodiments, it is preferred to have use zwitterionic polymers that possess permanently charged groups, which, without being bound by any theory, may improve non-fouling performance because the charged groups are ionically solvated with water. The presence of commonly used groups which can have permanent charges in the zwitterionic polymers can be detected by using XPS to analyze the elements present in the top approximately 1-50 nm of the surface. One representative group commonly used in zwitterions is nitrogen in quaternary amine groups. In sulfobetaine, elemental signal of nitrogen may be approximately equivalent to a signal for sulfur. Further, techniques such as TOF-SIMS may be used to identify zwitterionic groups in the grafted polymer layer. In some preferred embodiments, the grafted polymer layer contains XPS signals of nitrogen, and optionally sulfur.

In general, the grafted polymeric material may comprise repeat units corresponding to any of Formulae 1 to 12. By way of further example, the grafted polymeric material may comprise a zwitterionic polymer. By way of further example, polymeric material may comprise repeat units corresponding to Formula 1. By way of further example, the grafted polymeric material may comprise repeat units corresponding to Formula 2. By way of further example, the grafted polymeric material may comprise repeat units corresponding to Formula 3. By way of further example, the grafted polymeric material may comprise repeat units corresponding to Formula 4. Additionally, the grafted polymeric material may comprise, as pendant groups, any of the pendant groups disclosed herein. Thus, for example, the grafted polymeric material may comprise pendant groups corresponding to any of Formulae ZI-1 to ZI-7 or POA-1. In one particularly preferred embodiment, the grafted polymeric material corresponds to Formula 1 and comprises zwitterionic pendant groups. In another particularly preferred embodiment, the grafted polymeric material corresponds to Formula 3 and comprises sulfobetaine or carboxybetaine pendant groups. In one especially preferred embodiment, the grafted polymeric material comprises repeat units derived from sulfobetaine methacrylate, sulfobetaine acrylate, sulfobetaine acrylamide, sulfobetaine methacrylamide, carboxybetaine methacrylate, carboxybetaine acrylate, carboxybetaine acrylamide, or carboxybetaine methacrylamide monomers. In general, the height and any branching of the grafted polymeric material can help to overcome surface irregularities and defects, and increased branching may reduce the ability of fouling materials to penetrate the non-fouling layer.

The following examples will serve to further illustrate the disclosure, but it should be understood that the disclosure is not restricted to these specific examples. Parts and percentages are by weight unless otherwise stated.

Methods of Use

The photoactivatable copolymer disclosed herein may be used in the form of a medical device to which the photoactivatable copolymer is applied as a coating. Suitable medical devices include, but are not limited to surgical, medical or dental instruments, ophthalmic devices, wound treatments (bandages, sutures, cell scaffolds, bone cements, particles), appliances, implants, scaffolding, suturing material, valves, pacemaker, stents, catheters, rods, implants, fracture fixation devices, pumps, tubing, wiring, electrodes, contraceptive devices, feminine hygiene products, endoscopes, wound dressings and other devices, which come into contact with tissue, especially human tissue.

In one aspect, the present disclosure relates to medical devices, such as labware and components of diagnostic test kits, that may come into contact with biological fluids or biological systems and that have a reduced interaction with that biological fluid or system. Medical devices include, but are not limited to, diagnostic equipment, such tubes, bottles, bags, and other containers; fluid handling apparatus, such as intravenous (IV) systems including needles and hubs, cannulae, tubing, connectors and other fixtures; blood treatment and dialysis equipment, including dialyzers, filters, and oxygenators; anesthesia and respiratory therapy equipment, such as masks and tubing; drug delivery and packaging supplies, such as syringes, tubing, transdermal patches, inhalers, bags and bottles; catheters, tubes, and endoscopy equipment; and labware, including dishes, vials, plates and cell culture equipment.

Fibrous and Particulate Materials

In one aspect, the photoactivatable copolymer is coated directly on a fibrous material, incorporated into a fibrous material or coated indirectly on a fibrous material (e.g. coated on a different surface coating). These include wound dressings, bandages, gauze, tape, pads, sponges, including woven and non-woven sponges and those designed specifically for dental or ophthalmic surgeries (See, e.g., U.S. Pat. Nos. 4,098,728; 4,211,227; 4,636,208; 5,180,375; and 6,711.879), paper or polymeric materials used as surgical drapes, disposable diapers, tapes, bandages, feminine products, sutures, and other fibrous materials.

Fibrous materials are also useful in cell culture and tissue engineering devices. Bacterial and fungal contamination is a major problem in eukaryotic cell culture and this provides a safe and effective way to minimize or eliminate contamination of the cultures, while allowing selective attachment of the desired cells through the incorporation of directed adhesion proteins into the material.

The non-fouling agents are also readily bound to particles, including nanoparticles, microparticles, millimeter beads, or formed into micelles, that have uses in a variety of applications including cell culture, as mentioned above, and drug delivery. Non-fouling, biocompatible, polymeric micelles would prevent protein denaturation preventing activation of the immune response allowing for a more stealthy delivery of the desired therapeutic.

Implanted and Inserted Materials

The photoactivatable copolymer can also be applied directly to, or incorporated in, polymeric, metallic, or ceramic substrates. Suitable devices include, but are not limited to surgical, medical or dental instruments, blood oxygenators, pumps, tubing, wiring, electrodes, contraceptive devices, feminine hygiene products, endoscopes, grafts, stents, pacemakers, implantable cardioverter-defibrillators, cardiac resynchronization therapy devices, ventricular assist devices, heart valves, catheters (including vascular, urinary, neurological, peritoneal, interventional, etc.), shunts, wound drains, dialysis membranes, infusion ports, cochlear implants, endotracheal tubes, guide wires, fluid collection bags, sensors, wound treatments (dressings, bandages, sutures, cell scaffolds, bone cements, particles), ophthalmic devices, orthopedic devices (hip implants, knee implants, spinal implants, screws, plates, rivets, rods, intramedullary nails, bone cements, artificial tendons, and other prosthetics or fracture repair devices), dental implants, breast implants, penile implants, maxillofacial implants, cosmetic implants, valves, appliances, scaffolding, suturing material, needles, hernia repair meshes, tension-free vaginal tape and vaginal slings, tissue regeneration or cell culture devices, or other medical devices used within or in contact with the body or any portion of any of these.

The photoactivatable polymer composition can be applied to nearly any substrate known in the art for use in medical devices. Such substrates include, for example, plastics, elastomers, metals and the like. Specific materials include polyvinylchlorides (PVC), polycarbonates (PC), polyurethanes (PU), polypropylenes (PP)₁ polyethylenes (PE), silicones, polyesters, cellulose acetates, polymethylmethacrylates (PMMA), hydroxyethylmethacrylates, N-vinyl pyrrolidones, fluorinated polymers such as polytetrafluoroethylene, polyamides, polystyrenes, copolymers or mixtures of the above polymers and medical grade metals such as steel or titanium.

Preferably, the photoactivatable copolymer coating disclosed herein does not significantly adversely affect the desired physical properties of the device including, but not limited to, flexibility, durability, kink resistance, abrasion resistance, thermal and electrical conductivity, tensile strength, hardness, burst pressure, etc. In one embodiment, the tensile strength, modulus, device dimensions, or combinations thereof of the coated substrate are within 20%, preferably within 10%, more preferably within 5%, most preferably within 1% of the tensile strength, modulus, device dimensions, or combinations thereof of the uncoated substrate.

The compositions described herein resist preferably greater than 50%, 55%, 60%, 65%, 70%, 75%, 80%, 85%, 90%, 95%, 99%, or 99.9% of the adsorption of protein from solution, for example phosphate buffered saline (PBS), media, serum, or in vivo relative to an uncoated control for 1 day, 7 days, 14, 21, 30, 45, 60, 90, 120, 180, or 365 days.

Fibrinogen Adsorption

One advantage of the present disclosure is that the surface coatings disclosed herein are resistant to protein adsorption. One measure of the protein adsorption resistant surfaces of the present disclosure is the amount of fibrinogen that adsorbs to the surface per unit area. The coated surfaces of the present disclosure have a fibrinogen adsorption less than about 100 ng/cm². In one embodiment, the coated surface has a fibrinogen adsorption less than about 50 ng/cm². In one embodiment, the coated surface has a fibrinogen adsorption less than about 5 ng/cm². In one embodiment, the coated surface has a fibrinogen adsorption less than about 0.3 ng/cm². Representative coated surfaces of the invention have a fibrinogen adsorption less than about 100 ng/cm². In one embodiment, surfaces coated with a photoactivatable copolymer material have a fibrinogen adsorption less than about 50 ng/cm². In another embodiment, surfaces coated with a photoactivatable copolymer material have a fibrinogen adsorption less than about 10 ng/cm². In another embodiment, surfaces coated with a photoactivatable copolymer material have a fibrinogen adsorption less than about 5 ng/cm². In another embodiment, surfaces coated with a photoactivatable copolymer material have a fibrinogen adsorption less than about 0.3 ng/cm².

In one embodiment, surfaces coated with a photoactivatable copolymer material comprising a zwitterionic polymer have a fibrinogen adsorption less than about 100 ng/cm². In another embodiment, surfaces coated with a photoactivatable copolymer material comprising a zwitterionic polymer have a fibrinogen adsorption less than about 50 ng/cm². In another embodiment, surfaces coated with a photoactivatable copolymer material comprising a zwitterionic polymer have a fibrinogen adsorption less than about 5 ng/cm². In another embodiment, surfaces coated with a photoactivatable copolymer material comprising a zwitterionic polymer have a fibrinogen adsorption less than about 0.3 ng/cm².

Surfaces coated with the photoactivatable copolymers have increased protein resistance as compared to uncoated surfaces. This increased protein resistance is demonstrated by fibrinogen adsorption and mucin adsorption characteristics. For example, coating a surface with the photoactivatable copolymers disclosed herein may reduce fibrinogen adsorption by at least 50%, 55%, 60%, 65% 70%, 75%, 80%, 85%, 90%, 92% 95%, 97%, 98%, 99%, 99.9% or greater compared to surfaces that are uncoated and/or have no other protein resistant treatment.

Surfaces coated with the photoactivatable copolymers also have increased protein resistance as compared to surfaces coated with compositions of betaine or zwitterionic polymers. This increased protein resistance is demonstrated by fibrinogen adsorption and mucin adsorption characteristics. For example, coating a surface with the photoactivatable copolymers disclosed herein may reduce fibrinogen adsorption compared to surfaces that are coated with a composition including betaine or zwitterionic polymers.

The present disclosure relates to a method for improving the protein resistance of a surface of an article or a medical device. The method includes coating at least a portion of the surface with the photoactivatable copolymer composition and exposing at least a portion of the polymer composition to light to activate the composition.

The photoactivatable copolymer composition may be applied to a surface using any number of methods, including but not limited to spraying, dipping, printing, or flow-coating. Other methods of application known in the art are also to be considered within the scope of this disclosure. Furthermore, the copolymer may be used in solution or emulsified to reduce its viscosity for application to a surface. A diluent, if employed, may be allowed to evaporate, and this evaporation may be facilitated by applying energy via heat or radiation. Optionally, evaporation of all or part of the solvent may be accomplished after the copolymer has been activated by light.

Any solvent that is capable of dissolving or substantially dissolving the photoactivatable copolymer such that its viscosity is reduced for application may be used. Suitable solvents may include water, saline, methanol, ethanol, isopropanol, ethyl acetate, tetrahydrofuran, or mixed solvents.

Curing of the coating may be achieved by exposure to UV radiation, which may be produced by any convenient means. The curing time depends on a number of factors including the composition of the copolymer. The coating may have a range of thicknesses, from several nanometers up to several millimeters, preferably from 0.1 to 100 micrometers. Similarly, the substrate thickness may vary, from about 0.001 millimeters to about 100 millimeters, preferably from about 0.01 millimeters to about 10 millimeters.

The copolymers may be added to improve the protein resistance of the articles having metallic or polymeric surfaces. It is particularly suited for biomedical devices or components which come into contact with blood. These devices include, for example, stents, angioplasty guidewires, pacemaker leads, and heart valves (which generally have metal components but are not totally metal). Non-biomedical applications include, for example, the coating of glass and stainless steel containers used for protein solutions to prevent costly product loss during pharmaceutical processing and packaging.

In another aspect, the disclosure is directed to a method of grafting the copolymer to a surface of an article that includes the steps of providing an article having a surface and exposing the surface of the article to the photoactivatable copolymer and exposing the photoactivatable copolymer to a light source such as UV light to form covalent bonds to the surface of the article.

Non-Medical Applications

The photoactivatable copolymers can also be added to paints and other coatings and filters to prevent mildew, bacterial contamination, and in other applications where it is desirable to prevent fouling, such as marine applications (ship hull coatings), contact lenses, dental implants, coatings for in vivo sensors, textiles such as hospital drapes, gowns, or bedding, ventilation conduits, doorknobs, devices for separations, such as membranes for microbial suspension, biomolecule separation, protein fractionation, cell separation, waste water treatment, water purification, bioreactors, and food processing.

For non-medical applications, the copolymers described herein resist preferably greater than 50%, 55%, 60%, 65%, 70%, 75%, 80%, 85%, 90%, 95%, 99%, or 99.9% adsorption of a fouling material relative to an uncoated control for 1 day, 7 days, 14, 21, 30, 45, 60, 90, 120, 180, 365, or 1000 days.

These copolymers can also be used to treat surfaces of fibers, particulates and films for the applications of textiles, additives, electric/optical appliances, packaging materials and colorants/inks.

The copolymers described herein are stable over extended periods of time, retaining at least 25%, 30%, 35%, 40%, 45%, 50%, 55%, 60%, 65%, 70%, 75%, 80%, 85%, 90%, 95%, or 99% of their non-fouling, anti-thrombotic, and/or antimicrobial properties for extended periods of time, for example, at least 1, 7, 14, 21, 30, 45, 60, 90, 120, 180, 365, or 1000 days.

### EXAMPLES

### Example 1

### Synthesis of 4-benzoylphenyl methacrylate

### Synthesis of 4-benzoylphenyl methacrylate

4-benzoylphenyl methacrylate was synthesized in an esterification reaction between 4-hydroxybenzophenone and methacroyl chloride. 4-hydroxybenzophenone, 3.5 g (0.0177 mol), was dissolved in 90 mL of dichloromethane. While stirring, 5 mL (0.0354 mol) of triethylamine was added. Under ice-bath cooling (0° C. to 4° C.), 1.73 mL (0.0177 mol) of methacroyl chloride was added drop wise to the solution. The mixture was allowed to stir in the ice-bath for 1 hr after which it was stirred at room temperature for the duration of 18 hrs, after which it was washed with water twice. The organic layer was dried with Na₂SO4 and the solvent was removed under vacuum. The crude product was purified by column chromatography with dichloromethane as an eluent. 3.39 g, 71.9% yield.

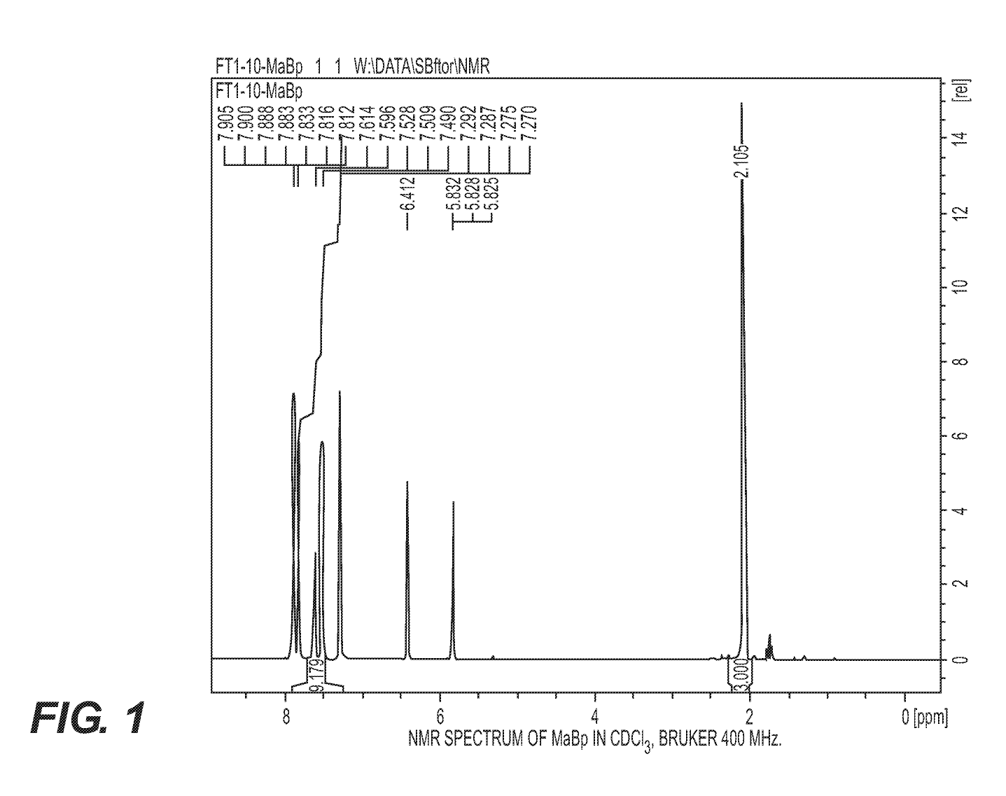

1H NMR (400 MHz, CDCl3), δ: 2.11 (s, 3H, α-methyl), 5.83 and 6.41 (d, 1H, CH2=), 7.27-7.91 (m 9H, phenyl) ppm. FIG. 1 shows the NMR spectrum of the resulting benzophenone methacrylate. Schematic 1 below illustrates the synthesis of benzophenone methacrylate according to Example 1.

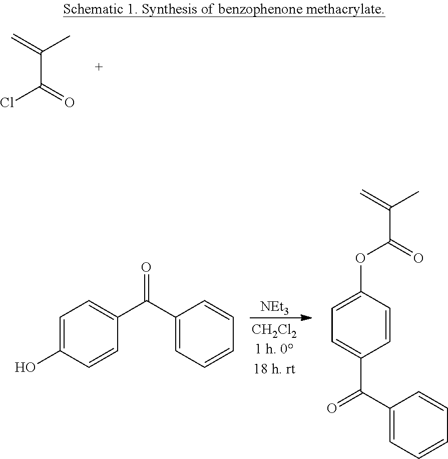

### Example 2

### Synthesis of 4′-methyl-4-methacrylatebenzophenone

### Synthesis of 4-methoxy-4′-methyl benzophenone

A zinc assisted Friedel-Crafts acylation was carried out to form the disubstituted benzophenone. Anisole (200 mmmol) was added along with the zinc catalyst (15 mg), and stirred at 60° C. After venting with nitrogen for 30 minutes, the acid chloride, p-toluoyl chloride (20 mmol) was added to the mixture, drop wise), along with an additional 200 mmol of anisole. The reaction was allowed to reflux under a nitrogen balloon for six hours. After cooling, the reaction was extracted with diethyl ether and washed with a 10% NaCl solution. The organic layer was dried with MgSO₄ and dried under vacuum. The product was purified through column chromatography, with a 9:1 hexane:EtOAc solution as an eluent. 3.66 g, 81% yield. ¹H NMR (Bruker 400 MHz, CDCl₃), δ (ppm): 2.46 (s, 3H), 3.91 (s, 3H), 6.97 (d, 2H), 7.29 (d, 2H), 7.69 (d, 2H), 7.83 (d, 2H).

### Synthesis of 4-hydroxy-4′-methyl benzophenone

4-methoxy-4′-methyl benzophenone (8.8 mmol) was placed in a round-bottom flask and allowed to dissolve in 40 mL of glacial acetic acid. To this solution, 20 mL of hydrobromic acid (48% aq.) was added. The reaction was allowed to reflux for 24 hours. After cooling, the solution was extracted with ethyl acetate and washed with water. The organic layer was dried with MgSO₄ and taken to dryness under vacuum.

### Synthesis of 4′-methyl-4-methacrylatebenzophenone

4-hydroxy-4′-methyl benzophenone, 3.40 g (0.016 mol), was dissolved in 90 mL of dichloromethane. While stirring, 4.82 mL (0.032 mol) of triethylamine was added. Under ice-bath cooling, 1.66 mL (0.016 mol) of methacroyl chloride was added dropwise to the solution. After reaction in the ice-bath for 1 hr, the reaction allowed to run at room temperature for additional 23 hrs, after which it was washed with water twice. The organic layer was dried with Mg₂SO₄ and the solvent was removed under vacuum. The crude product was purified by column chromatography with dichloromethane as an eluent. 3.60 g, 72% yield. ¹HNMR (Bruker 400 MHz, CDCl₃), δ: 2.11 (s, 3H), 2.46 (s, 3H), 5.83 (s, 1H), 6.41 (s, 1H), 7.26-7.88 (m, 8H) ppm

### Example 3

### Synthesis of 3′-methyl′4-methacrylatebenzophenone

As described above, the synthesis of 4-methoxy-3′-methyl benzophenone was carried out via a zinc assisted Friedel-Crafts acylation reaction, with m-toluoyl chloride (20 mmol) as the acid chloride. After reaction, the solution then extracted with diethyl ether and then washed with a 10% NaCl solution. The organic layer was then dried with MgSO₄, and then rotavaped to obtain a dark orange crude oil. Then the product was purified via column chromatography, with 10:1 hexane:EtOAc as an eluent. 4.15 g, 92% yield. ¹H NMR (Bruker 400 MHz, CDCl₃), δ: 2.44 (s, 3h), 3.91 (s, 3H), 6.98 (d, 2H), 7.37-7.54 (m, 4) and 7.84 (d, 2H).

### Synthesis of 4-hydroxy-3′-methyl benzophenone

4-methoxy-3′-methyl benzophenone (8.8 mmol) was placed in a round-bottom flask and allowed to dissolve in 40 mL of glacial acetic acid. To this solution, 20 mL of hydrobromic acid (48% aq.) was added. The reaction was allowed to reflux for 24 hours. After cooling, the solution was extracted with ethyl acetate and washed with water. The organic layer was dried with MgSO₄ and taken to dryness under vacuum.

### Synthesis of 3′-methyl-4-methacrylatebenzophenone

4-hydroxy-3′-methyl benzophenone, 3.82 g (0.018 mol), was dissolved in 90 mL of dichloromethane. While stirring, 5.42 mL (0.0384 mol) of triethylamine was added. Under ice-bath cooling, 1.82 mL (0.018 mol) of methacroyl chloride was added drop wise to the solution. The mixture was allowed to stir in the ice-bath for 1 hr and then the reaction allowed to run at room temperature for additional 23 hrs. The solution was washed with water, and the organic layer was dried with Mg₂SO₄ and the solvent was removed under vacuum. The crude product was purified by column chromatography with dichloromethane as an eluent. 3.50 g, 70%. 1H NMR (400 MHz, CDCl3), δ: 2.11 (s, 3H), 2.45 (s, 3H), 5.83 and 6.41 (d, 1H), 6.98 (d, 2H), 7.37-7.54 (m, 4H) and 7.84 (d, 2H).

### Example 4

### Synthesis of 4-nitro-4′-benzoylphenyl methacrylate

### Synthesis of 4-nitro-4′-methoxybenzophenone

A zinc assisted Friedel-Crafts acylation was carried out to form the disubstituted benzophenone. Anisole (200 mmol) was added along with the zinc catalyst (15 mg), and stirred at 60° C. After venting with nitrogen for 30 minutes, the acid chloride, 4-nitrobenzoyl chloride (20 mmol) was added to the mixture, dropwise), along with an additional 200 mmol of anisole. The reaction was allowed to reflux under a nitrogen balloon for six hours. After cooling, the reaction was extracted with diethyl ether and washed with a 10% NaCl solution. The organic layer was dried with MgSO₄ and dried under vacuum. The product was purified through column chromatography, with dichloromethane as an eluent. 5.02 g, 98% yield. ¹HNMR (Bruker 400 MHz, CDCl₃), δ: 3.93 (s, 3H), 7.01 (d, 2H), 7.83 (d, 2H), 7.89 (d, 2H), 8.35 (d, 2H).

### Synthesis of 4-nitro-4′-hydroxybenzophenone

4-nitro-4′-methoxybenzophenone (0.0195 mol) was placed in a round-bottom flask and allowed to dissolve in 65 mL of glacial acetic acid. To this solution, 25 mL of hydrobromic acid (48% aq.) was added. The reaction was allowed to reflux for 24 hours. After cooling, the solution was extracted with ethyl acetate and washed with water. The organic layer was dried with MgSO₄ and taken to dryness under vacuum to yield 2.30 g of crude product.

### Synthesis of 4-nitro-4′-benzoylphenyl methacrylate

4-nitro-4′-hydroxybenzophenone (0.0095 mol) was placed in a round-bottom flask dissolved in 43 mL of methylene chloride. Triethylamine, (2.75 mL, 0.019 mol), was added and the flask was capped. The flask was placed in an ice bath, and methacryloyl chloride (0.99 mL, 0.0095 mol) was added dropwise. The solution was allowed to stir in ice bath for 1 hour, and then allowed to react at room temperature for an additional 23 hours. After reaction, the solution was washed with water and the organic layer was dried with MgSO₄ and rotavaped. The brownish crude product was purified by column chromatography with methylene chloride as an eluent, to yield a white solid. 2.28 g, 77% yield. 1H NMR (Bruker 400 MHz CDCl₃), δ (ppm): 2.11 (s, 3H), 5.85 (s, 2H), 6.42 (d, 2H), 7.32 (d, 2H), 7.88 (d, 2H), 7.95 (d, 2H), 8.36 (d, 2H)

### Example 5

### Synthesis of 3-nitro-4′-benzoylphenyl methacrylate

### Synthesis of 3-nitro-4′-methoxybenzophenone

A zinc assisted Friedel-Crafts acylation was carried out to form the disubstituted benzophenone. Anisole (200 mmmol) was added along with the zinc catalyst (15 mg), and stirred at 60° C. After venting with nitrogen for 30 minutes, the acid chloride, 3-nitrobenzoyl chloride (20 mmol) was added to the mixture, dropwise), along with an additional 200 mmol of anisole. The reaction was allowed to reflux under a nitrogen balloon for six hours. After cooling, the reaction was extracted with diethyl ether and washed with a 10% NaCl solution. The organic layer was dried with MgSO₄ and dried under vacuum. The product was purified through column chromatography, with dichloromethane as an eluent. 4.00 g, 78% yield. ¹H NMR (Bruker 400 MHz, CDCl₃), δ(ppm): 3.934 (s, 3H), 7.01-8.59 (aromatic 8H).

### Synthesis of 3-nitro-4′-hydroxybenzophenone

3-nitro-4′-methoxybenzophenone (15.5 mmol) was placed in a round-bottom flask and allowed to dissolve in 50 mL of glacial acetic acid. To this solution, 20 mL of hydrobromic acid (48% aq.) was added. The reaction was allowed to reflux for 24 hours. After cooling, the solution was extracted with ethyl acetate and washed with water. The organic layer was dried with MgSO₄ and taken to dryness under vacuum. The final product was purified with column chromatography. 2.43 g, 64% yield.

### Synthesis of 3-nitro-4′-benzoylphenyl methacrylate

3-nitro-4′-hydroxybenzophenone, 2.42 g (9.9 mmol) was placed in a round-bottom flask dissolved in 43 mL of methylene chloride. Triethylamine, (2.89 ml, 19.8 mmol), was added and the flask was capped. The flask was placed in an ice bath, and methacryloyl chloride was added dropwise. The solution was allowed to stir on ice bath for 1 hour, and then react at room temperature for an additional 23 hours. The solution was washed with water and the organic layer was dried with MgSO₄ and rotavaped. The brownish crude product was purified by column chromatography with methylene chloride as an eluent, to yield a white solid. 2.34 g, 76% yield. ¹H NMR (Bruker 400 MHz, CDCl₃), δ(ppm): 2.11 (s, 1H), 5.59 (s, 1H), 6.43 (s, 1H), 7.01-8.59 (aromatic 8H).

### Example 6

### Synthesis of 4′-carboxy-4-benzoylphenyl methacrylate

### Synthesis of 4-methoxy-4′-carboxy benzophenone

4-methoxy-4′-methyl benzophenone 5.1 g (0.0226 mol) was placed in a round-bottom flask with potassium permanganate, 12.43 g (0.0787 mol) and dissolved in 2M NaOH and pyridine (15 mL/15 mL). The reaction was allowed to reflux for 6 hours. The resulting brown slush was filtered with copious amounts of warm water and extracted with ethyl acetate and the organic layer discarded. 1M HCl was added to the aqueous layer until the pH was approximately 1. The resulting precipitate was filtered and washed with copious amounts of water and dried. 3.33 g, 58% yield. ¹HNMR (Bruker 400 MHz, DMSO), δ: 3.88 (s, 3H), 7.10 (d, 2H), 7.77 (d, 2H), 8.05 (d, 2H), 8.10 (d, 2H), 13.30 (s, 1H)

### Synthesis of 4-hydroxy-4′-carboxy benzophenone

4-methoxy-4′-carboxy benzophenone, 3.30 g (0.0129 mol) was placed in a round-bottom flask and dissolved in 48% HBr (7.11 mL), glacial acetic acid (3.57 mL) and acetic anhydride (3.57 mL) and refluxed 24 hrs. After the reaction was cooled, the solution was poured onto ice and filtered with a Buchner funnel, washing with copious amounts of water and dried. 2.99 g, 95.5% yield. ¹HNMR (Bruker 400 MHz, DMSO), δ: 7.10 (d, 2H), 7.77 (m, 4H), 8.09 (d, 2H), 10.52 (s, 1H), 13.27 (s, 1H)

### Synthesis of 4′-carboxy-4-benzoylphenyl methacrylate

4-hydroxy-4′-carboxy benzophenone, 2.96 g (0.0122 mol) was dissolved in 2M NaOH (11 mL) in a round-bottom flask, which after capping was placed in an ice-bath. Methacryoyl chloride (0.0254 mol) was added dropwise, and the reaction was allowed to run at 0° C. for 1 hr., followed by 1 hr reaction at room temperature. The resulting yellow slush mixture was treated with 1M HCl until the pH was around 1. The solid was filtered with a Buchner funnel, washed with copious amounts of water and dried. The resulting crude was recrystallized in an aqueous ethanol solution. 1.46 g, 40% yield. ¹HNMR (Bruker 400 MHz, DMSO), δ: 2.03 (s, 3H), 5.96 (s, 1H), 6.34 (s, 1H), 7.40 (d, 2H), 7.84 (d, 2H), 7.86 (d, 2H), 8.11 (d, 2H), 13.34 (s, 1H)

### Example 7

### Synthesis of 3′-caboxy-4-benzoylphenyl methacrylate

### Synthesis of 4-methoxy-3′-carboxy benzophenone

4-methoxy-3′-carboxy benzophenone was synthesized following the same procedure as described above in example 6 for of 4-methoxy-4′-carboxy benzophenone except starting with 4-methoxy-3′-methyl benzophenone. 3.39 g of 4-methoxy-3′-carboxy benzophenone was obtained at 53% yield. ¹HNMR (Bruker 400 MHz, DMSO), δ: 3.88 (s, 3H), 7.11 (d, 2H), 7.68-7.93 (m, 4H) 8.19 (d, 2H), 13.31 (s, 1H).

### Synthesis of 4-hydroxy-3′-carboxy benzophenone

synthesized following the same method in example 6 as for 4-hydroxy-4′-carboxy benzophenone. 3.02 g of 4-hydroxy-3′-carboxy benzophenone was synthesized at 94% yield. ¹HNMR (Bruker 400 MHz, DMSO), δ: 6.91 (d, 2H), 7.67 (m, 3H), 7.91 (d, 1H), 8.17 (d, 2H), 10.50 (s, 1H), 13.26 (s, 1H)

### Synthesis of 3′-carboxy-4-benzoylphenyl methacrylate

4-hydroxy-3′-carboxy benzophenone (0.0104 mol) was dissolved in 2M NaOH in a round-bottom flask, capped and placed in an ice-bath. Methacryoyl chloride was added dropwise, and the reaction was allowed to run at 0° C. for 1 hr., with an additional 23 hours of reaction time at room temperature. The resulting yellow slush mixture was treated with 1M HCl until the pH was around 1. The solid was filtered with a Buchner funnel, washed with copious amounts of water and dried. The resulting crude was recrystallized in toluene. 1.61 g, 50% yield. ¹HNMR (Bruker 400 MHz, DMSO), δ: 2.04 (s, 3H), 5.96 (s, 1H), 6.34 (s, 1H), 7.41 (d, 2H), 7.72-7.84 (m, 4H), 8.25 (d, 2H), 13.32 (broad s, 1H)

### Example 8

### Poly(SBMA-co-MaBp) was Copolymerized with Different Ratio

A series of copolymers featuring sulfobetaine methacrylate (SBMA) and the 4-benzoylphenyl methacrylate (MaBp) were synthesized. Such polymers include those containing 99%, 97%, 95%, 90%, 80% and 74% SBMA and 1%. 3%. 5%, 10%, 20% and 266 MaBp. AIBN was used as an initiator.

The monomers were dissolved in methanol and the reaction vessel was degassed, after which the initiator was added, and the vessel was degassed with nitrogen again. The reaction was allowed to run for 18 hours at constant reflux. After completion, the precipitate was washed with cold methanol, dried, and suspended in water. Yields ranged from 99% to 85%. Schematic 4 below illustrates the structure of the SBMA-MaBp copolymer formed.

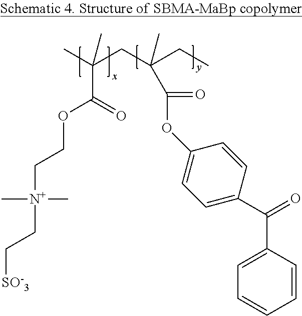

### Example 9

### Copolymers of SBMA-Substituted MaBp

Copolymers of SBMA and various substituted methacryloxy benzophenone monomers were synthesized by free radical polymerization using AIBN as initiator. Following the same procedure as Example 8, the molar ratio of SBMA/substituted MaBp monomers was kept constant as 90/10. After polymerization, the NMR analysis showed that SBMA ratio in the copolymers ranged from 92% to 98%

### Example 10

### Copolymer Coatings on Polyurethane Catheters

Polyurethane catheters were coated with SBMA-substituted MaBp copolymers and tested for fibrinogen resistance. Copolymers of SBMA-co-4′-methyl-4-methacrylatebenzophenone (4MMB) and SBMA-co-3′-methyl-4-methacrylatebenzophenone (3MMB) were made into 10% (wt/v) solution in water with 0.4% (wt/v) NaCl and dip-coated on polyurethane catheters. After exposed to 30 J/cm² of UV light in the VelaCure Chamber, the coated samples were washed in a 5% saline solution for 24 hours in an incubator (37° C., 120 rpm), and later rinsed with deionized water and dried. By radio-labeled fibrinogen analysis, these SBMA-co-4MMB and SBMA-co-3MMB could reduce fibrinogen adsorption by 97.5% and 98.4% respectively using untreated polyurethane catheter as control.

Fibrinogen adsorption reduction on polyurethane catheters

| | Avg. | | % |
|---|---|---|---|
| Sample Description | CPM | SD | reduction |
| Control polyurethane catheter | 14949 | 2824 | — |
| Sample coated with poly(SBMA-co-3MMB) | 235 | 101 | 98.4 |
| Sample coated with poly(SBMA-co-4MMB) | 369 | 167 | 97.5 |

### Example 11

### Copolymer Coatings on Titanium Wires

The same two copolymers from Example 10 were dip coated on titanium wires, UV exposed and washed in the same way. The copolymer coated titanium wires were found could reduce fibrinogen adsorption by 89% to 95%.

1-56. (canceled)

57. A photoactivatable fouling-resistant copolymer comprising:
(a) a photoactivatable monomer including an aryl ketone derivative having one or more polar groups or alkyl groups, and
(b) a hydrophilic monomer.

58. The photoactivatable fouling-resistant copolymer of claim 57 having repeating units of formula: 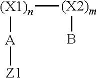
wherein Z1-A-(X1)ₙ is a photoactivatable monomer, A represents an aryl ketone derivative, Z1 represents one or more polar groups or alkyl groups, X1 represents a hydrocarbyl, X2 represents a hydrocarbyl, B represents a hydrophilic moiety, m is an integer of 1 or greater and n is a integer of 0 or greater.

59. The copolymer of claim 57, wherein the photoactivatable monomer is present in an amount of 0.1 to 70% by weight based on the total weight of the copolymer.

60. The copolymer of claim 57, wherein the hydrophilic monomer is present in an amount of 30 to 99.9% by weight based on the total weight of the copolymer.

61. The copolymer of claim 57, wherein the photoactivatable monomer comprises the one or more polar groups or alkyl groups.

62. The copolymer of claim 57, wherein the polar group of the photoactivatable monomer comprises at least one of carboxylic acid, a sulfonate group, a nitro group, a hydroxyl, carboxy, amino, amide, phosphate or ether group.

63. The copolymer of claim 57, wherein the alkyl group of the photoactivatable monomer or the hydrophilic monomer comprises at least one of a methyl, ethyl, or propyl group.

64. The copolymer of claim 57, wherein the copolymer has a weight average molecular weight ranging from 5,000 to 200,000.

65. The copolymer of claim 57, wherein the photoactivatable monomer comprises at least one unsaturated group.

66. The copolymer of claim 57, wherein the hydrophilic monomer comprises at least one unsaturated group.

67. The copolymer of claim 65, wherein the unsaturated group is a methacrylate, acrylate, acrylamide, vinyl group or mixtures thereof.

68. The copolymer of claim 57, wherein the photoactivatable monomer has one of following structures:

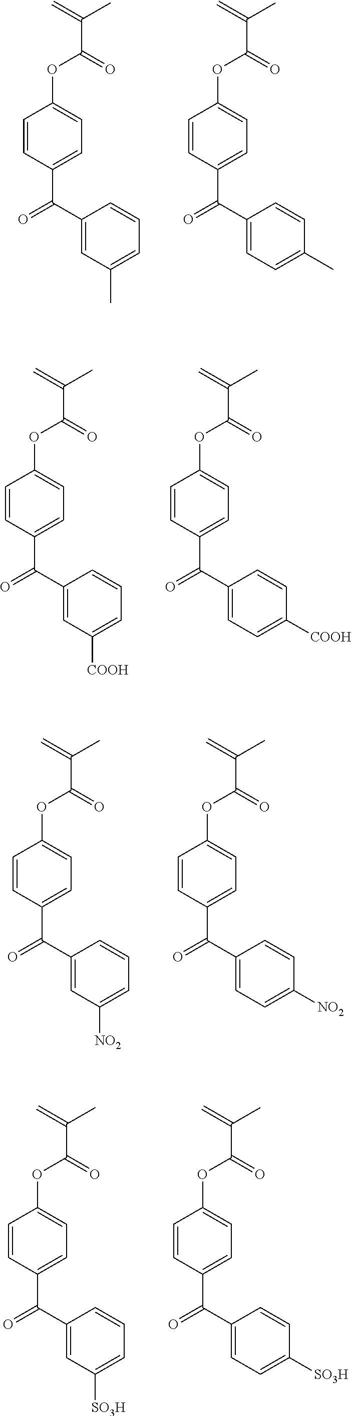

69. The copolymer of claim 57, wherein the hydrophilic monomer is a sulfobetaine monomer, a carboxybetaine monomer, a carboxyammonium monomer or a sulfoammonium monomer.

70. The copolymer of claim 57, wherein the copolymer comprises at least 90 mol % of a structure represented by Formula 1: 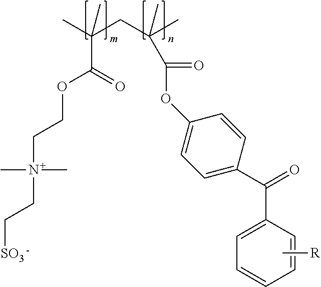
wherein R is a sulfonate group, a carboxylic group, a methyl group, or a nitro group.

71. The copolymer of claim 57, wherein the aryl ketone derivative of the photoactivatable monomer comprises a benzophenone derivative.

72. The copolymer of claim 57, wherein the photoactivatable monomer comprises 4-benzoylphenyl methacrylate.

73. The copolymer of claim 57, wherein the hydrophilic monomer comprises sulfobetaine methacrylate.

74. The copolymer of claim 57, wherein the copolymer is characterized by reducing adsorption of protein at the surface of a substrate by at least 50%.

75. A substrate having a non-fouling layer disposed on the surface of the substrate, wherein the non-fouling layer comprises the photoactivatable copolymer of claim 57.

76. A method of modifying a surface of a substrate comprising: applying a photoactivatable fouling-resistant copolymer in solution to the surface of the substrate, wherein the copolymer comprises a photoactivatable monomer including an aryl ketone derivative having one or more polar groups or alkyl groups, and a hydrophilic monomer; and applying energy to the copolymer in solution to form radical groups that covalently bond to functional groups on the surface of the substrate.
